(19) United States
(12) Patent Application Publication
(10) Pub. No.: US 2024/0351370 A1
(43) Pub. Date: Oct. 24, 2024

(54) MOBILE ROBOTS WITH SHAPE-CHANGING TENSEGRITY STRUCTURES

(71) Applicant: Colorado State University Research Foundation, Fort Collins, CO (US)

(72) Inventors: Sydney Spiegel, Fort Collins, CO (US); Jianguo Zhao, Fort Collins, CO (US); Jiefeng Sun, Fort Collins, CO (US); Andrew Stefka, Fort Collins, CO (US); Joshua Christler, Fort Collins, CO (US)

(73) Assignee: Colorado State University Research Foundation, Fort Collins, CO (US)

(21) Appl. No.: 18/638,447

(22) Filed: Apr. 17, 2024

Related U.S. Application Data
(60) Provisional application No. 63/460,029, filed on Apr. 18, 2023.

(51) Int. Cl. B60B 19/04; B25J 5/00

(52) U.S. Cl. CPC B60B 19/04; B25J 5/007

(57) ABSTRACT

Aspects of the present disclosure include a robotic wheel that includes a tensegrity structure, an inner hub, an outer hub, and a cable. The tensegrity structure includes multiple rigid rods and multiple elastic cables, and the tensegrity structure defines a longitudinal axis, a first end and a second end. The inner hub is disposed at the first end of the tensegrity structure and the outer hub is disposed at the second end of the tensegrity structure. The cable is in contact with the outer hub, extends through the tensegrity structure parallel to the longitudinal axis, and extends through the inner hub. The cable is operable to retract to transition the tensegrity structure to a collapsed state and to extend to transition the tensegrity structure an expanded state.

### CROSS-REFERENCE TO RELATED APPLICATIONS

This application claims the benefit of U.S. Provisional Application No. 63/460,029, filed Apr. 18, 2023, which is hereby incorporated by reference in its entirety.

### GOVERNMENT FUNDING

This invention was made with government support under grant numbers 2126039 and 2230321 awarded by the National Science Foundation. The government has certain rights in the invention.

### FIELD OF THE INVENTION

The present disclosure is directed to robots that include tensegrity structures.

### BACKGROUND OF THE INVENTION

Conventional wheels can readily move on hard flat surfaces, but also have inherent flaws. For example, conventional wheels cannot easily overcome obstacles, such as steps. Moreover, conventional wheels need to be very large to have the surface area required for travel on snow or sand, increasing the overall cost and weight. Additionally, conventional wheels generally require a suspension system for most wheeled applications adding cost, complexity, and weight. Accordingly, there is a need in the art for wheels that reduce cost and weight, while improving locomotion. It is with these thoughts in mind, among others, that the robotic wheel of the present disclosure was conceived.

Conventional robotic arms are heavy and include various joints to allow translational and/or rotational movement of the robotic arm. And these conventional robotic arms are generally limited by their design, which may be aimed at carrying out specific tasks. Moreover, designing robotic arms to carry out specific tasks can increase the cost of conventional robotic arms. Accordingly, there is a need in the art for a robotic arm that reduces cost and is adaptable. It is with these thoughts in mind, among others, that the robotic arm of the present disclosure was conceived.

### SUMMARY

Aspects of the present disclosure include a robotic wheel. The robotic wheel includes a tensegrity structure, an inner hub, an outer hub, and a cable spanning between the inner hub and the outer hub. The tensegrity structure defines a longitudinal axis and includes multiple rigid rods and multiple elastic cables. The inner hub is disposed at a first end of the tensegrity structure. The outer hub is disposed at a second end, which is opposite the first end, of the tensegrity structure. The cable is in contact with the outer hub and extends through the tensegrity structure parallel to the longitudinal axis of the tensegrity structure. The cable extends through the inner hub and is operable to retract and extend. Retracting the cable can transition the tensegrity structure to a collapsed state. Extending the cable can transition the tensegrity structure to an expanded state.

In certain instances, the cable extends through the tensegrity structure coincident to the longitudinal axis of the tensegrity structure.

In certain instances, the robotic wheel includes a hollow shaft that is coupled to the inner hub. The hollow shaft can be coincident to the longitudinal axis of the tensegrity structure.

In certain instances, a plane defined by the outer hub is substantially perpendicular to the longitudinal axis of the tensegrity structure when the tensegrity structure is in the expanded state, the collapsed state, and transitioning between the expanded state and the collapsed state.

In certain instances, a plane defined by the inner hub is substantially parallel to a plane defined by the outer hub when the tensegrity structure is in the expanded state, the collapsed state, and transitioning between the expanded state and the collapsed state.

In certain instances, the outer hub is coupled to outer ends of at least some of the rigid rods via compliant connectors.

In certain instances, each opposing end of each of the rigid rods includes an endcap. The endcaps can be configured to increase friction between the tensegrity structure and a surface supporting the tensegrity structure.

In certain instances, a width defined by the tensegrity structure is greater when the tensegrity structure is in the expanded state than when the tensegrity structure is in the collapsed state.

In certain instances, a height defined by the tensegrity structure is greater when the tensegrity structure is in the collapsed state than when the tensegrity structure is in the expanded state.

In certain instances, the tensegrity structure includes six rigid rods and twenty-four elastic cables. The six rigid rods and the twenty-four elastic cables can be arranged in a 6-bar icosahedron tensegrity structure.

Aspects of the present disclosure include a robot. The robot includes a body, a first tensegrity wheel, and a second tensegrity wheel. The first tensegrity wheel is coupled to a first shaft extending outward from a first side of the body, and the first tensegrity wheel is operable to rotate about a first longitudinal axis. The second tensegrity wheel is coupled to a second shaft extending outward from a second side of the body, and the second tensegrity wheel is operable to rotate about a second longitudinal axis.

In certain instances, the robot includes a third tensegrity wheel and a fourth tensegrity wheel. The third tensegrity wheel is coupled to a third shaft extending outward from the first side of the body, and the third tensegrity wheel is operable to rotate about a third longitudinal axis. The fourth tensegrity wheel is coupled to a fourth shaft extending outward from the second side of the body, and the fourth tensegrity wheel is operable to rotate about a fourth longitudinal axis.

In certain instances, the first tensegrity wheel is operable to transition between an expanded state and a collapsed state along the first longitudinal axis, and the second tensegrity wheel is operable to transition between an expanded state and a collapsed state along the second longitudinal axis. In certain instances, when each of the first tensegrity wheel and the second tensegrity wheel are in the expanded state a width of the robot is greater than when each of the first tensegrity wheel and the second tensegrity wheel are in the collapsed state. In certain instances, when each of the first tensegrity wheel and the second tensegrity wheel are in the collapsed state a clearance height of the robot is greater than when each of the first tensegrity wheel and the second tensegrity wheel are in the expanded state.

In certain instances, the robot includes a jumping mechanism coupled to the body. The jumping mechanism is configured actuate to cause the robot to separate from a surface supporting the robot. In certain instances, the jumping mechanism includes a bistable mechanism.

In certain instances, the robot includes a tail extending from a back side of the body.

In certain instances, the robot includes a first set of paddles that can be coupled to the first tensegrity wheel and a second set of paddles that can be coupled to the second tensegrity wheel.

In certain instances, the robot includes an unmanned aerial vehicle coupled to the body.

Aspects of the present disclosure include a robotic arm. The robotic arm includes a first base, a second base, one or more tensegrity structures, and multiple cables. The first base includes a first end effector and the second base includes a second end effector. The tensegrity structures define a longitudinal axis and are disposed in series between the first base and the second base. The cables each extend between the first base and the second base. Each cable is configured to retract towards or extend from the first base. Each of the cables is substantially parallel to the longitudinal axis when the longitudinal axis is substantially linear.

In certain instances, the robotic arm includes a cable guide that extends radially outward from an interface between a first tensegrity structure and a second tensegrity structure that are included in the one or more tensegrity structures. The cable guide can include multiple apertures that correspond to each of the cables.

In certain instances, the cables are equally spaced along a circumference defined radially outward from the longitudinal axis of the tensegrity structures.

In certain instances, the cables include a first cable, a second cable, and a third cable. In certain instances, the robotic arm includes a first motor, a second motor, and a third motor each enclosed withing a housing of the first base. The first motor is configured to retract or extend the first cable. The second motor is configured to retract or extend the second cable. The third motor is configured to retract or extend the third cable.

In certain instances, the robotic arm expands or contracts along the longitudinal axis when each of the plurality of cables are extended or retracted at the same rate.

In certain instances, the longitudinal axis transitions between a straight configuration and a bent configuration when at least two cables of the plurality of cables are extended or retracted at a different rate.

In certain instances, the cables each define a length between the first base and the second base, and the longitudinal axis of the tensegrity structures is substantially linear when the length of each of the cables are substantially equal.

In certain instances, the cables each define a length between the first base and the second base, and the longitudinal axis of the tensegrity structures is substantially non-linear when the length one cable is different than another cable.

In certain instances, the first end effector includes a first robotic claw extending outward from the first base and the second end effector includes a second robotic claw extending outward from the second base. Each of the first robotic claw and the second robotic claw are operable to transition between an open position and a closed position.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a perspective view of a robot including two robotic wheels that include tensegrity structures configured to transition between an expanded state and a collapsed state, according to embodiments of the present disclosure.

FIG. 2 illustrates a front view of a robot including two robotic wheels having tensegrity structures configured to transition between an expanded state and a collapsed state, according to embodiments of the present disclosure.

FIGS. 3A-3B illustrate a perspective view and a front view, respectively, of a robot including two robotic wheels having tensegrity structures configured to transition between an expanded state and a collapsed state, according to embodiments of the present disclosure.

FIG. 4 illustrates a front view of a robot with the tensegrity structures illustrated overlain in both an expanded state and a collapsed state, according to embodiments of the present disclosure.

FIG. 5 illustrates a front view the robotic wheels each including a tensegrity structure and corresponding cable, according to embodiments of the present disclosure.

FIG. 6 illustrates a perspective view of one robotic wheel that includes a tensegrity structure and a corresponding cable, according to embodiments of the present disclosure.

FIG. 7 illustrates a perspective view of the body of a robot that includes a jumping mechanism and a tail, according to embodiments of the present disclosure.

FIG. 8 illustrates a schematic of the components and working principle of the jumping mechanism.

FIG. 9 illustrates a perspective view of a robot that includes four tensegrity structures as wheels, according to embodiments of the present disclosure.

FIG. 10 illustrates a perspective view of a remote-controlled car that includes four tensegrity structures used as wheels, according to embodiments of the present disclosure.

FIGS. 11A-11C illustrate a robot that includes four tensegrity structures used as wheels and configured to drive across land (as illustrated in FIG. 11A) and water (as illustrated in FIG. 11B) with paddles coupled to the tensegrity structure (as illustrated in FIG. 11C).

FIGS. 12A-12B illustrate a drone that includes four tensegrity structures used as wheels and configured to drive across the ground (as illustrated in FIG. 12A) and fly through the air (as illustrated in FIG. 12B).

FIGS. 13A-13B illustrate a tensegrity structure that includes six rods and twenty-four cables 108 (e.g., a 6-bar icosahedron tensegrity structure) in a perspective view and a flattened view, respectively, according to embodiments of the present disclosure.

FIG. 14 illustrates a comparison of simulation and experimental results from analyzing the force-displacement relationship to collapse a tensegrity wheel.

FIGS. 15A-15B illustrate a maximum climbable height for a step with an overhang (as illustrated in FIG. 15A) and without and overhang (as illustrated in FIG. 15B).

FIG. 16 illustrates the results for a maximum jumping height experiment showing the jumping trajectory.

FIGS. 17A-17D illustrates the results for a maximum step climbing tests with expanded wheels an no step overhang (as illustrated in FIG. 17A), with expanded wheels and a step overhang (as illustrated in FIG. 17B), with collapsed wheels and no step overhang (as illustrated in FIG. 17C), and with collapsed wheels with a step overhang (as illustrated in FIG. 17D).

FIG. 18 illustrates an obstacle course that was constructed to demonstrate the ability of an example robot to navigate different terrains.

FIGS. 19A-19G illustrate an example robot constructed in accordance with embodiments of the present disclosure traversing across grass (FIG. 19A), gravel (FIG. 19B), sand (FIG. 19C), sharp rocks (FIG. 19D), foliage (FIG. 19E), snow (FIG. 19F), and ice (FIG. 19G).

FIGS. 20A-20B illustrate a perspective view of a robot (FIG. 20A) and a detailed view of a portion of the robotic arm including tensegrity structures, according to embodiments of the present disclosure.

FIG. 21 illustrates a perspective view of the first base including collapsing mechanisms disposed therein, according to embodiments of the present disclosure.

FIGS. 22A-22B illustrate a robotic arm in a collapsed state (FIG. 22A) and an expanded state (FIG. 22B) in a perspective view, according to embodiments of the present disclosure.

FIGS. 23A-23B illustrate side views of a robotic arm including one tensegrity structure (as illustrated in FIG. 23B) and the corresponding robotic arm 602 range of motion, according to embodiments of the present disclosure.

FIGS. 24A-24B illustrate side views of a robotic arm including two tensegrity structures (as illustrated in FIG. 24B) and the corresponding robotic arm range of motion (as illustrated in FIG. 24A), according to embodiments of the present disclosure.

FIGS. 25A-25B illustrate side views of a robotic arm including three tensegrity structures (as illustrated in FIG. 25B) and the corresponding robotic arm range of motion (as illustrated in FIG. 25A), according to embodiments of the present disclosure.

FIGS. 26A-26B illustrate side views of a robotic arm including four tensegrity structures (as illustrated in FIG. 26B) and the corresponding robotic arm range of motion (as illustrated in FIG. 26A), according to embodiments of the present disclosure.

FIG. 27 illustrates a side view of a robot that includes two tensegrity robots coupled together in series, according to embodiments of the present disclosure.

FIG. 28 illustrates a robot that includes a drone for aerial manipulation and a robot extending therefrom, according to embodiments of the present disclosure.

FIG. 29 illustrates a perspective view of four tensegrity robots coupled to a common object and each extending therefrom, according to embodiments of the present disclosure.

FIGS. 30A-30F illustrate an example robotic arm navigating a vertical pipe, according to embodiments of the present disclosure.

FIGS. 31A-31F illustrate two robotic arms demonstrating various functionality, according to embodiments of the present disclosure.

FIG. 32 illustrates an example computing system that may implement various systems and methods discussed herein.

### DETAILED DESCRIPTION

Disclosed herein are robots that include tensegrity structures. Section I of the present disclosure relates to embodiments of robots that include tensegrity structures as wheels. Section II of the present disclosure relates to embodiments of robots that include one or more tensegrity structures in a robotic arm.

### I. Robots Including Tensegrity Structures as Wheels

Aspects of the present disclosure relate to a robot that includes tensegrity structures as wheels. Each tensegrity wheel can be collapsed inward toward the body of the robot or expanded outward away from the body of the robot. In some examples, the robot includes a jumping mechanism, which enables the robot to jump. In some examples, the robot includes a tail with a passive wheel behind the robot, which stabilizes the robot as it moves. The ability to change the shape of each tensegrity wheel and, when equipped, the ability of the robot to jump enhances the ability of the robot to navigate difficult environments.

Each tensegrity wheel includes and outer wheel hub and an inner wheel hub. A cable is in communication with the outer wheel hub, such as by a knot in the cable bearing against an outer surface of the outer wheel hub. The cable extends through the tensegrity wheel along the axis of rotation of the tensegrity wheel, and extends through the inner wheel hub. When the cable is retracted inward towards the robot frame, the outer wheel hub is retracted inward toward the inner wheel hub such that the tensegrity wheel contracts. When the cable is extended outward away from robot frame, the outer wheel hub is extended outward away from the inner wheel hub and the tensegrity wheel expands.

The tensegrity wheel disclosed herein can provide several advantages over conventional wheels. For example, tensegrity wheels can provide cost savings over conventional wheels. For example, tensegrity wheels can use less materials than conventional wheels of the same size. The reduction in materials can lead benefits such as cost savings and a reduced environmental impact. Tensegrity wheels can provide shock absorption, which can reduce or eliminate the need for a suspension system that may be required for robots having conventional wheels. Eliminating the need for a suspension system can reduce materials and costs. In some instances, the tensegrity wheels can serve as a shock-absorbing system to allow the robot to survive substantial falls.

As another example of advantages over conventional wheels, tensegrity wheels are highly adaptable to different situations. The ability of the tensegrity wheels to change shape can allow the robot to enter narrow spaces and/or have greater clearance. Moreover, tensegrity wheels can easily be adjusted to suit specific needs (e.g., traveling over significant obstacles, traveling through snow, traveling through water). The tensegrity wheels may travel over obstacles like steps or soft terrains (e.g., sand, snow, water) more easily than conventional wheels. Moreover, the tensegrity wheels can be much lighter in weight than conventional wheels designed with a large surface area to travel over obstacles or soft terrain. In some aspects, robots having tensegrity wheels can be used in emergency management application, such as search and rescue operations (e.g., after natural disasters like earthquakes) or during radiation monitoring (e.g., after nuclear leakage), requiring a robot to traverse various unstructured terrains. First responders could use tensegrity wheeled robots to search for survivors after accidents or monitor dangerous environments.

As another example of advantages over conventional wheels, the tensegrity wheels can have a high weight to load-carrying capacity. The tensegrity wheels can be self-supporting, meaning tensegrity wheels do not need internal air pressure to maintain shape. This can be useful in situations where it is impractical or impossible to inflate wheels. As another example, tensegrity wheels are lightweight, making them easy to transport and deploy, which is in situations where weight and space are a concern (e.g., acrospace applications, military applications).

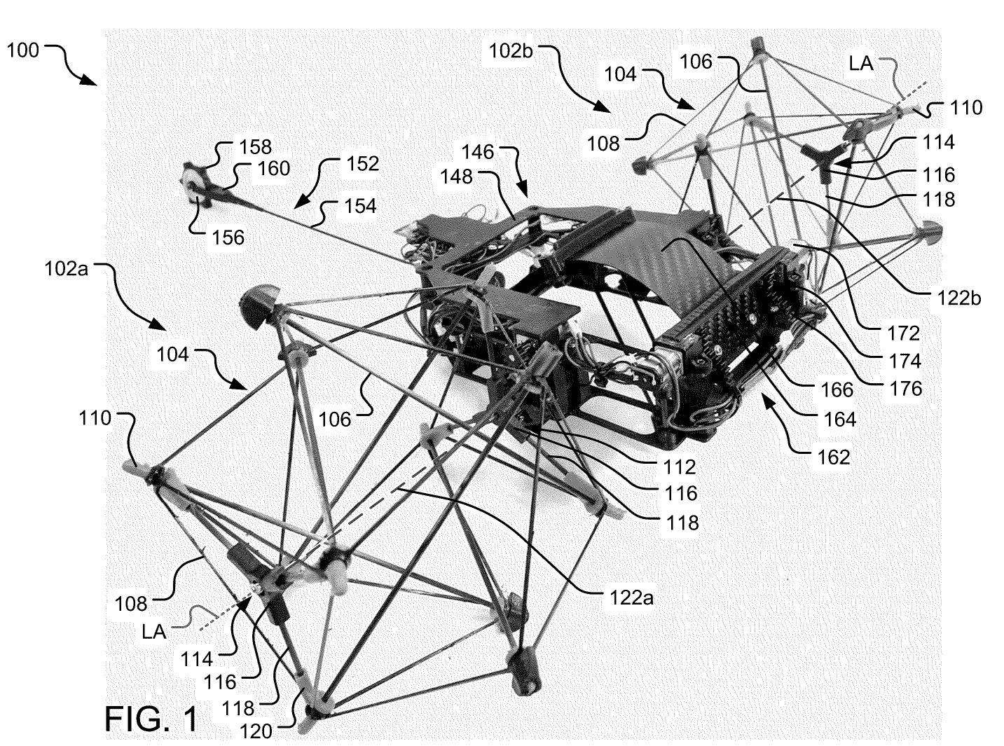

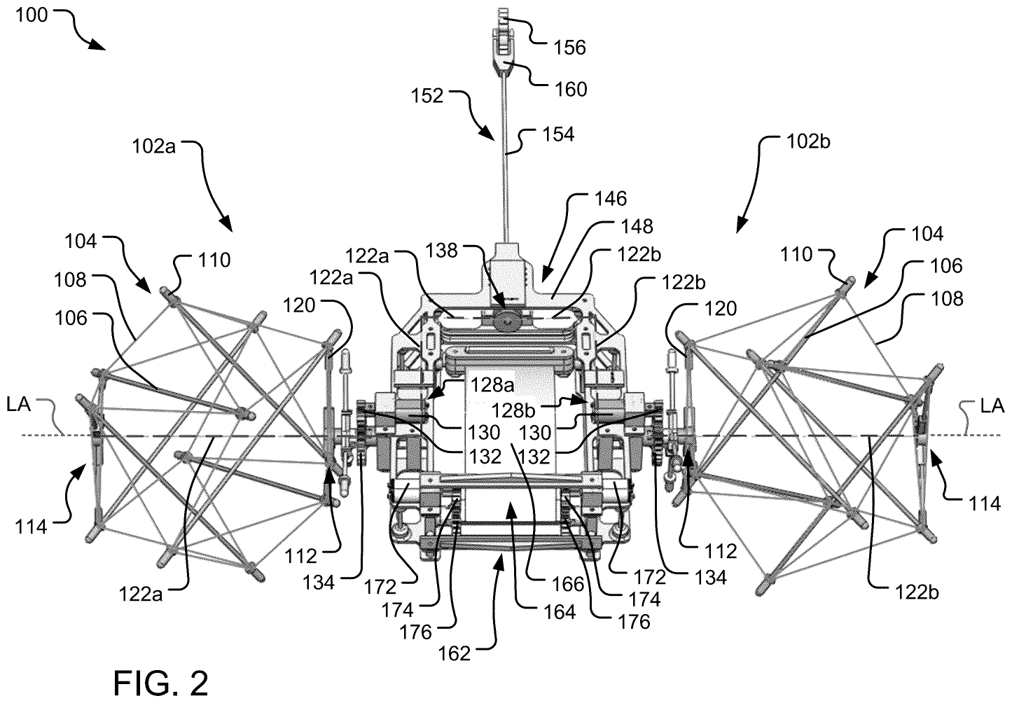

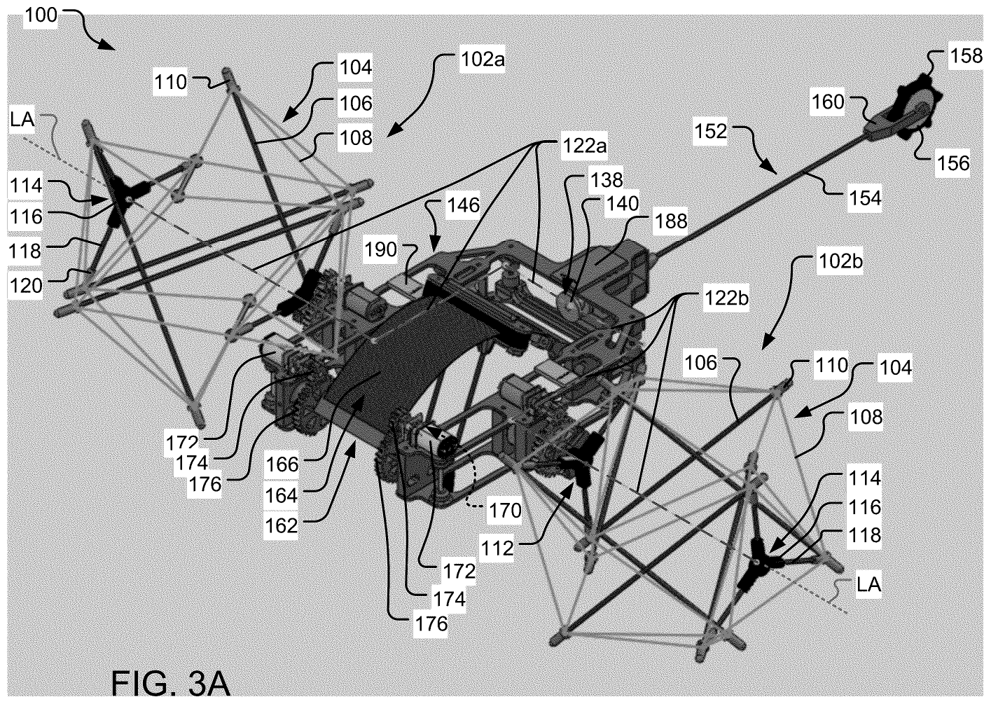

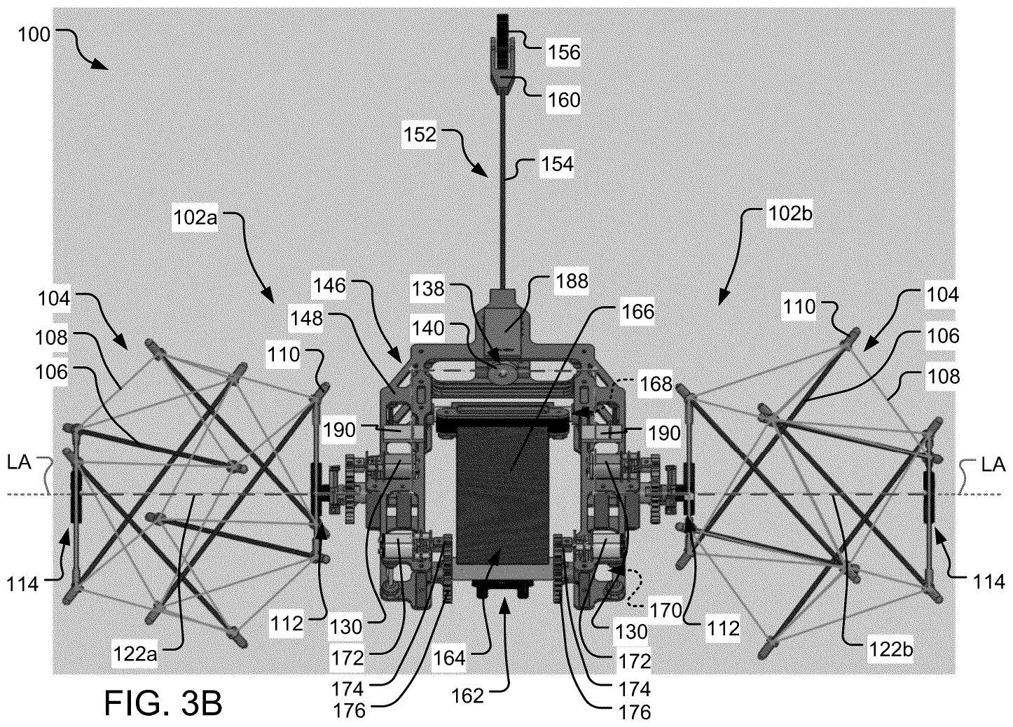

With reference to FIGS. 1-3B, a robot 100 including robotic wheels 102 (e.g., right robotic wheel 102a, left robotic wheel 102b) is illustrated in a perspective view (in FIG. 1), a front view (in FIG. 2), and a perspective view and front view (in FIGS. 3A-3B, respectively), according to embodiments of the present disclosure. In some examples, the robot 100 includes a tail 152. In some examples, the robot 100 includes a jumping mechanism 162. When the robot 100 includes robotic wheels 102 and a jumping mechanism 162, the robot 100 can use its multi-modal locomotion capabilities to traverse various indoor and outdoor environments including, among others, uneven, soft, and steep terrains. In some aspects, the robot 100 equipped with multiple locomotion modes is better suited for safely entering, exploring, and leaving environments over robots having only a single mode. Each of these features is discussed in turn below.

Beginning with the robotic wheels 102, each robotic wheel 102 (e.g., right robotic wheel 102a, left robotic wheel 102b) includes a tensegrity structure 104, an inner hub 112, an outer hub 114, and a cable 122 (e.g., right cable 122a, left cable 122b). The cable 122 is in communication with the outer hub 114, extends through the open center of the tensegrity structure 104, and extends through the inner hub 112. The cable is routed to a collapsing mechanism 138, which includes a motor 140 and pulley 142 configured to actuate the cable 122.

Actuation (e.g., retracting, extending) of the cable 122 (e.g., via a collapsing mechanism 138 that can include a motor and pulley) causes a change in shape or otherwise transition of the tensegrity structure 104 between an expanded state and a collapsed state. That is, the cable 122 can be retracted inward (e.g., toward the body 146 of the robot 100) to cause the tensegrity structure 104 to transition from an expanded state to a collapsed state (e.g., collapse laterally inward). The cable 122 can be extended outward (e.g., away from the body 146 of the robot 100) to cause the tensegrity structure 104 to transition from a collapsed state to an expanded state (e.g., expand laterally outward).

Turning now to the tensegrity structure 104 (also referred to as a tensegrity wheel), and continuing with FIGS. 1-3B, the tensegrity structure 104 includes multiple rods 106 (also referred to as rigid rods) and multiple cables 108 (also referred to as elastic cables). The rods 106 are loaded in pure compression and the cables 108 are loaded in pure tension, such that the tensegrity structure 104 can elastically deform in response to an applied force (e.g., via retraction of cable 122). And the tensegrity structure 104 can rebound after the force is removed (e.g., via extension of cable 122). In some aspects, the tensegrity structure 104 includes six rods 106 and twenty-four cables 108 (e.g., a 6-bar icosahedron tensegrity structure).

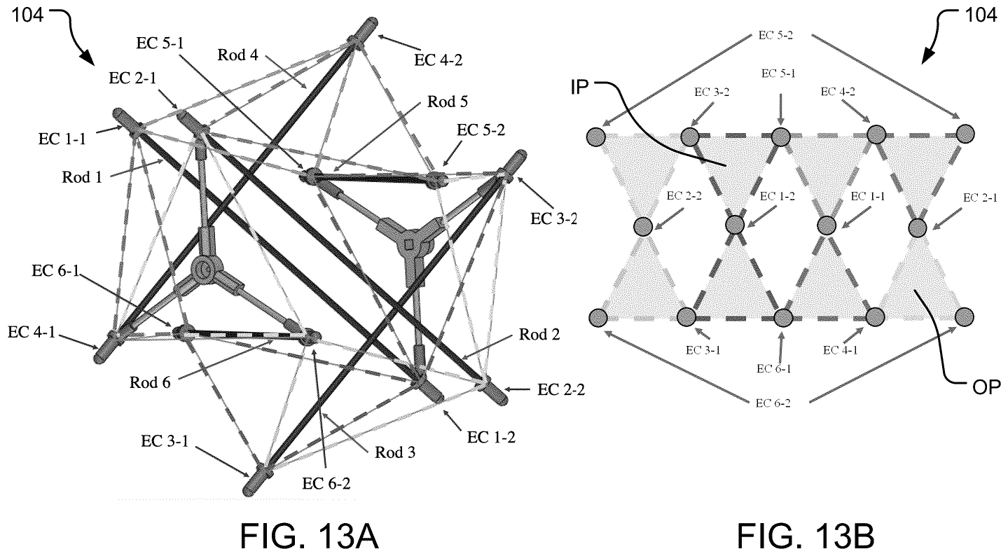

Turning briefly to FIGS. 13A-13B, a tensegrity structure 104 that includes six rods 106 and twenty-four cables 108 (e.g., a 6-bar icosahedron tensegrity structure) is illustrated in a perspective view (FIG. 13A) and a flattened view (FIG. 13B), respectively, according to embodiments of the present disclosure. It should be noted that, FIGS. 1-6 do not include a reference number label for each rod 106, cable 108, and endcap 110 to avoid obfuscating the drawings. FIGS. 13A-13B include a label for each rod 106 (which are labeled as Rod 1, Rod 2, Rod 3, Rod 4, Rod 5, and Rod 6) and each endcap 110 (which are labeled as EC 1-1, EC 1-2, EC 2-1, EC 2-2, EC 3-1, EC 3-2, EC 4-1, EC 4-2, EC 5-1, EC 5-2, EC 6-1, EC 6-2).

Each of the cables 108 (which are not labeled in FIGS. 13A-13B) are illustrated as dashed lines. An inner plane IP (e.g., vertical plane), as illustrated for example in FIG. 13B, is defined by the three cables that span between EC 3-2 and EC 5-1, span between EC 5-1 and EC 1-2, and span between EC 1-2 and EC 3-2. An outer plane OP (e.g., vertical plane), as illustrated for example in FIG. 13B, is defined by the three cables that span between EC 2-1 and EC 6-2, span between EC 6-2 and EC 4-1, and span between EC 4-1 and EC 2-1. The inner plane and outer plane are substantially parallel to each other, as illustrated for example in FIG. 13A. And the inner plane and outer plane remain substantially parallel to each other as the tensegrity structure 104 transitions between an expanded state and a collapsed state. Each of the inner plane and outer plane are substantially perpendicular to the longitudinal axis of the tensegrity structure 104. And each of the inner plane and outer plane remain substantially perpendicular to the longitudinal axis of the tensegrity structure 104 as the tensegrity structure 104 transitions between an expanded state and a collapsed state.

Returning to FIGS. 1-3B, the rods 106, which are pure axial loaded compression members, are rigid (or otherwise stiff). Each of the rods 106 is isolated from the other rods 106. In some embodiments, the rods 106 are lightweight and stiff. In some examples, the rods 106 are made from carbon fiber (e.g., round carbon fiber). The cables 108, which are pure tension members, are elastic. In some examples, the cables 108 are 3D-printed. In some examples, the cables 108 are made from a highly flexible thermoplastic polyurethane (TPU) filament (Ninja-flex 85A). In some examples, the cables 108 have a rectangular cross-section. In some examples, the length of the cables 108 is equal to approximately 60-percent of the length of the rods 106 to provide an ideal tensegrity structure 104.

The tensegrity structure 104 is self-supporting, as the tensegrity structure 104 does not require internal air pressure to maintain an inflated state. Because it is self-supporting, the tensegrity structure 104 provides an advantage over conventional wheels that requires a chamber, which can rupture or otherwise pop, to maintain an internal air pressure. The tensegrity structure 104 of the robotic wheel 102 cannot rupture like a conventional wheel.

The tensegrity structure 104 provides shock absorption during wheeling. That is, the tensegrity structure 104 can elastically deform in response to external loads (e.g., rolling over bumps), such that the tensegrity structure 104 can rebound after the external load is removed. By providing shock absorption, the tensegrity structure 104 provides advantages over conventional robot wheel systems that require a suspension. In other words, the shock absorbing capability of the tensegrity structure 104 can reduce, or in some cases eliminate, the need for the robot 100 to include a suspension system, which can reduce weight and cost.

The tensegrity structures 104 are light weight. In one example, when the rods 106 are approximately 130 mm in length, the tensegrity structure 104 weights approximately 17 grams (e.g., approximately 6.8-percent of the total weight of the robot 100). By including light wheels, the robot 100 can maximize its jump height when using its jumping mechanism 162. Although they are lightweight, the tensegrity structures 104 are durably. In one example, a tensegrity structure 104 was constructed and the cables 108 maintained elasticity even after transitioning to a collapsed state approximately 300 times.

In some embodiments, endcaps 110 (also referred to as rod endcaps) are disposed at the outer end of the rods 106. In some examples, each of the endcaps 110 is configured to receive an end of one of the rods 106 therein (e.g., an end of a rod 106 is press fit into the endcap 110). The endcaps 110 can each define a length. In some embodiments, the length of each of the endcaps 110 is between approximately 10 mm and approximately 14 mm. In some examples, the length of each of the endcaps 110 is between approximately 11 mm and approximately 13 mm. In some examples, the length of each of the endcaps 110 is approximately 12 mm.

The endcaps 110 are configured to generate a friction force against a surface (e.g., the ground) as the tensegrity structure 104 rotates about its longitudinal axis LA during wheeling on the ground. That is, the endcaps 110 can provide a higher coefficient of friction with respect to a surface than a tensegrity structure 104 that does not include endcaps 110. In some embodiments, the endcaps 110 are made of a polymer (e.g., rubber). In some examples, the endcaps 110 are made of an abrasion-resistant thermoplastic polyurethane (TPU). In some examples, the endcaps 110 are 3D-printed from a TPU filament (e.g., Cheetah 95A).

Each tensegrity structure 104 defines a longitudinal axis LA (e.g., in the lateral direction). When the tensegrity structure 104 is rotatably coupled to the robot 100, the longitudinal axis LA of the tensegrity structure 104 is the axis of rotation. That is, the tensegrity structure 104 rotates about its longitudinal axis LA. Rotating one or more of the tensegrity structures 104 about its longitudinal axis LA causes the robot 100 to move (e.g., translate across a surface, rotate on a surface). For example, rotating an opposing pair of tensegrity structures 104 in the same direction can cause the robot 100 to locomote (e.g., in a forward direction, in a reverse direction) across a surface (e.g., the ground). Rotating only one tensegrity structure 104 or rotating an opposing pair of tensegrity structures in opposite directions can cause the robot 100 to rotate on the surface.

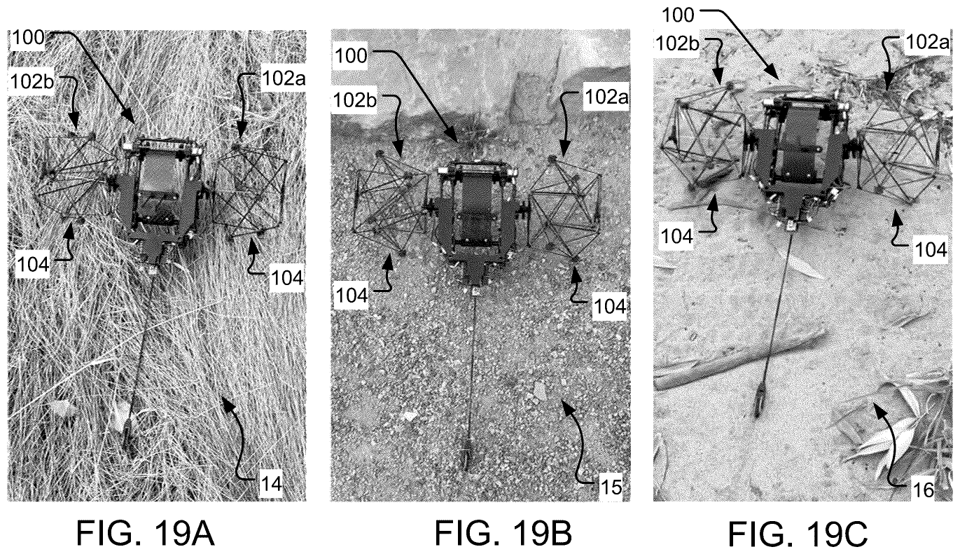

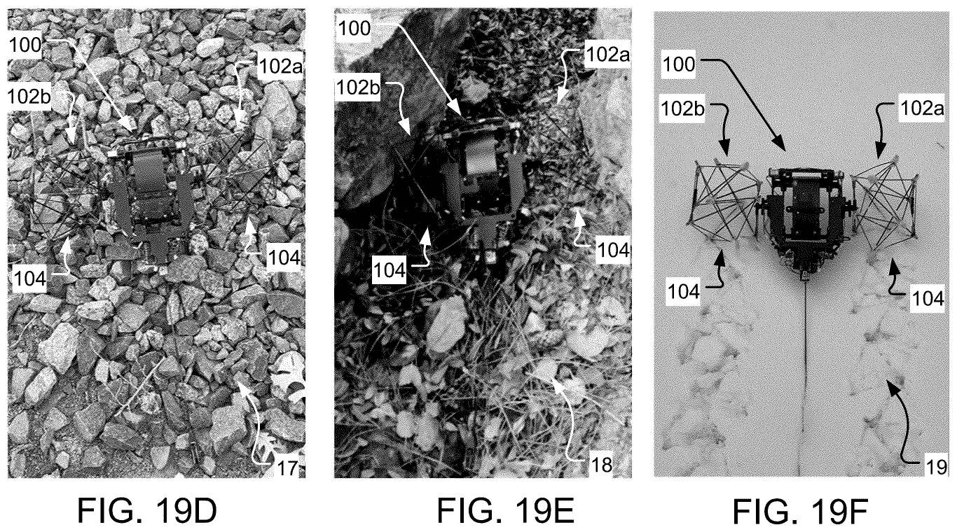

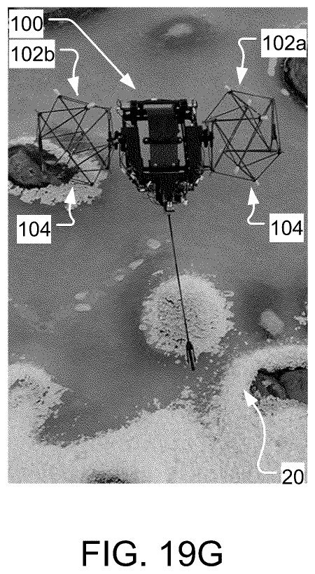

The tensegrity structures 104 can allow the robot 100 to traverse (or otherwise travel) across a variety of surfaces (e.g., indoor surfaces, outdoor terrain). For example, in FIGS. 19A-19G, the robot 100 is illustrated in perspective views traversing across various types of outdoor terrain, according to embodiments of the present disclosure. An example robot 100 was constructed with robotic wheels 102 including tensegrity structures 104. The robotic wheels 102 allowed the robot 100 to traverse across grass 14 (as illustrated for example in FIG. 19A), gravel 15 (as illustrated for example in FIG. 19B), sand 16 (as illustrated for example in FIG. 19C), sharp rocks 17 (as illustrated for example in FIG. 19D), foliage 18 (as illustrated for example in FIG. 19E), snow 19 (as illustrated for example in FIG. 19F), and ice 20 (as illustrated for example in FIG. 19G). In some aspects, the tensegrity structures 104 used as wheels excel at traveling over obstacles and through many terrains (e.g., sand, steps, snow) that conventional wheels struggle to travel over.

Turning now to the inner hub 112 and the outer hub 114, and returning to FIGS. 1-3B, the inner hub 112 (also referred to as the inner wheel hub) and the outer hub 114 (also referred to as the outer wheel hub) are disposed at opposite ends of the tensegrity structure 104. That is, the inner hub 112 is disposed at the laterally inward side of the tensegrity structure 104 and the outer hub 114 is disposed at the laterally outward side of the tensegrity structure 104. Together, the inner hub 112 and outer hub 114 allow the tensegrity structure 104 to be wheeled, while also allowing the tensegrity structure 104 to be collapsed or expanded. The inner hub 112 and the outer hub 114 can include one or more same or similar components, elements, or portions. For example, each of the inner hub 112 and outer hub 114 can include a central portion 116, rods 118 emanating from the central portion 116, and/or compliant connectors 120, which are each discussed in turn below.

The longitudinal axis of each central portion 116 is coaxially aligned with the longitudinal axis LA of the tensegrity structure 104. The cable 122 is connected to the central portion 116 of the outer hub 114 (e.g., via a knot tied in the end of the cable 122, via a bearing) such that the cable 122 does not become twisted when the tensegrity structure 104 rotates about its longitudinal axis LA. The central portion 116 of the inner hub 112 receives the cable 122 therethrough, such that the cable 122 can retract or extend through the central portion 116 of the inner hub 112. In some examples, the central portion 116 is made of a polymer (e.g., injection-molded plastic). In some embodiments, the central portion 116 is made of a thermoplastic (e.g., nylon). In some examples, the central portion 116 is 3D printed from a carbon fiber enhanced filament (e.g., Nylon-X). In some examples, the central portion 116 is made from metal (e.g., aluminum).

In some embodiments, multiple rods 118 (e.g., three rods 118) extend radially outward from the central portion 116. In some embodiments, one end of each rod 118 is received (e.g., press fit) into the central portion 116 and the opposite end of each rod 118 is received (e.g., press fit) into a compliant connector 120. Each compliant connector 120 couples the inner hub 112 or the outer hub 114 to the tensegrity structure 104. In some aspects, each compliant connector 120 couples each rod 118 emanating from the central portion 116 to an end of a rod 106 of the tensegrity structure 104. In some examples, the rods 118 define a relatively circular cross-section that defines a diameter. In some examples, the diameter of each rod 118 is approximately 2 mm. In some embodiments, the rods 118 are made from carbon fiber.

The inner hub 112 defines an inner plane (e.g., a vertical plane) and the outer hub 114 defines an outer plane (e.g., a vertical plane). In some aspects, the inner plane and the outer plane are each substantially perpendicular to the longitudinal axis LA of the tensegrity structure 104 when the tensegrity structure 104 is in an expanded state, when the tensegrity structure 104 is in a collapsed state, and when the tensegrity structure 104 is transitioning between an expanded state and a collapsed state. In some aspects, the inner plane and the outer plane are substantially parallel to each other when the tensegrity structure 104 is in an expanded state, when the tensegrity structure 104 is in a collapsed state, and when the tensegrity structure 104 is transitioning between an expanded state and a collapsed state. In some aspects, the inner plane defined by the inner hub 112 is parallel to (or coplanar with) the inner plane IP defined by three cables as illustrated in FIG. 13B. In some aspects, the outer plane defined by the outer hub 114 is parallel to (or coplanar with) the outer plane OP defined by three cables as illustrated in FIG. 13B.

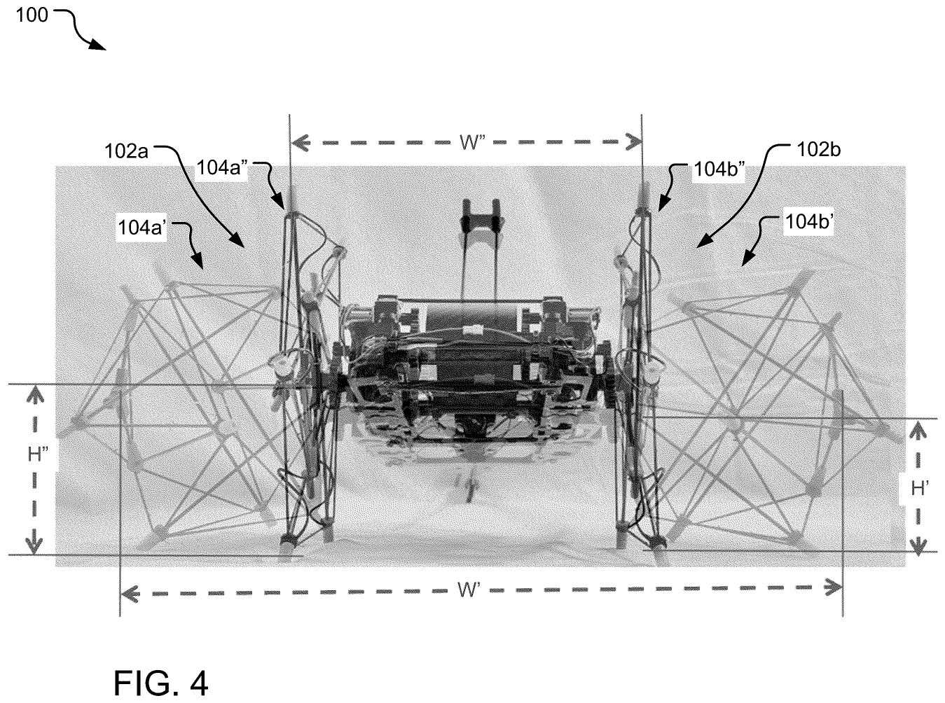

Turning to FIG. 4, the robotic wheels 102 (e.g., right robotic wheel 102a, left robotic wheel 102b) of a robot 100 are illustrated in a front view with the tensegrity structures 104 illustrated overlain in both an expanded state and a collapsed state. As previously noted, each robotic wheel 102, and correspondingly each tensegrity structure 104, can transition between an expanded state and a collapsed state. In FIG. 4 for example, the tensegrity structures 104′ (e.g., tensegrity structure 104a′, tensegrity structure 104b′) are illustrated in an expanded state and the tensegrity structures 104″ (e.g., tensegrity structure 104a″, tensegrity structure 104b″) are illustrated in a collapsed state. In some examples, the tensegrity structures 104 each from an expanded isosahedron in the expanded state and a disk shape (e.g., flat) in the collapsed state. For example, rods 106 on opposing sides of a median plane that is perpendicular to the longitudinal axis LA of the tensegrity structure 104 can come into contact with each other when the tensegrity structure 104 is in the collapsed state. In some examples, the width of a tensegrity structure 104 in the collapsed state is substantially equal to twice (i.e., two times) the diameter of the rods 106.

As each tensegrity structure 104 transitions, the tensegrity structure 104 changes shape and, correspondingly, causes a change in the dimensions (e.g., width, height, volume). Because the tensegrity structure 104 can change shape, the robotic wheels 102 provide an increased ability for the robot 100 to navigate various environments over conventional wheels. For example, the tensegrity structure 104 can be collapsed inward (or otherwise transitioned to a collapsed state) to decrease the width and/or increase the height of the tensegrity structure 104. Decreasing the width of the tensegrity structure 104, which correspondingly decreases the width of the robot 100, can allow the robot 100 to traverse through a narrower space. Increasing the height of the tensegrity structure 104, which correspondingly increases the ground clearance of the robot 100, can allow the robot 100 to traverse over a taller obstacle.

Continuing with FIG. 4, the tensegrity structures 104 define a width (e.g., width W′, width W″) in the lateral direction. In some aspects, the width is measured substantially parallel to the longitudinal axis LA of each tensegrity structure 104 (e.g., substantially horizontal) between outer hub 114 (of tensegrity structure 104a′, of tensegrity structure 104a″) and outer hub 114 (of tensegrity structure 104b′, of tensegrity structure 104b″). When the tensegrity structures 104 transition from an expanded state to a collapsed state, the width defined by the tensegrity structures 104 decreases. That is, as illustrated for example in FIG. 4, the width W″ of the tensegrity structures 104″ in the collapsed state is less than the width W′ of the tensegrity structures 104′ in the expanded state. When the tensegrity structures 104 transition from a collapsed state to an expanded state, the width defined by the tensegrity structures 104 increases. That is, as illustrated for example in FIG. 4, the width W′ of the tensegrity structures 104′ in the expanded state is greater than the width W″ of the tensegrity structures 104″ in the collapsed state.

In some embodiments, the width W′ defined by the tensegrity structures 104′ in an expanded state is between approximately 380 mm and 420 mm. In some examples, the width W′ is between approximately 390 mm and 410 mm. In some examples, such as when the length of each rod 106 is approximately 130 mm, the width W′ is approximately 400 mm. In some embodiments, the width W″ defined by the tensegrity structures 104″ in a collapsed state is between approximately 160 mm and 200 mm. In some examples, the width W″ is between approximately 170 mm and 190 mm. In some examples, such as when the length of each rod 106 is approximately 130 mm, the width W″ is approximately 180 mm.

The tensegrity structures 104 define a height (e.g., height H′, height H″) in the radial direction (also referred to as the clearance height). In some aspects, the height is measured substantially perpendicular to the longitudinal axis LA of each tensegrity structure 104 (e.g., substantially vertical) between a surface supporting the tensegrity structures 104 and the longitudinal axis LA of the tensegrity structures 104. When the tensegrity structures 104 transition from an expanded state to a collapsed state, the height defined by the tensegrity structures 104 increases. That is, as illustrated for example in FIG. 4, the height H″ of the tensegrity structures 104″ in the collapsed state is greater than the height H′ of the tensegrity structures 104′ in the expanded state. When the tensegrity structures 104 transition from a collapsed state to an expanded state, the height defined by the tensegrity structures 104 decreases. That is, as illustrated for example in FIG. 4, the height H′ of the tensegrity structures 104′ in the expanded state is less than the height H″ of the tensegrity structures 104″ in the collapsed state.

In some embodiments, the height H′ defined by the tensegrity structures 104′ in an expanded state is between approximately 55 mm and 95 mm. In some examples, the height H′ is between approximately 65 mm and 85 mm. In some examples, such as when the length of each rod 106 is approximately 130 mm, the height H′ is approximately 75 mm. In some embodiments, the height H″ defined by the tensegrity structures 104″ in a collapsed state is between approximately 75 mm and approximately 115 mm. In some examples, the height H″ is between approximately 85 mm and 105 mm. In some examples, such as when the length of each rod 106 is approximately 130 mm, the height H″ is approximately 95 mm.

Each tensegrity structure 104 defines a volume (e.g., defined by the cables 108). When the tensegrity structures 104 transition from an expanded state to a collapsed state, the volume defined by the tensegrity structure 104 decreases. That is, as illustrated for example in FIG. 4, the volume of the tensegrity structure 104″ in the collapsed state is less than the volume of the tensegrity structure 104′ in the expanded state. When the tensegrity structure 104 transitions from a collapsed state to an expanded state, the volume defined by the tensegrity structure 104 increases. That is, as illustrated for example in FIG. 4, the volume of the tensegrity structures 104′ in the expanded state is greater than the volume of the tensegrity structure 104″ in the collapsed state.

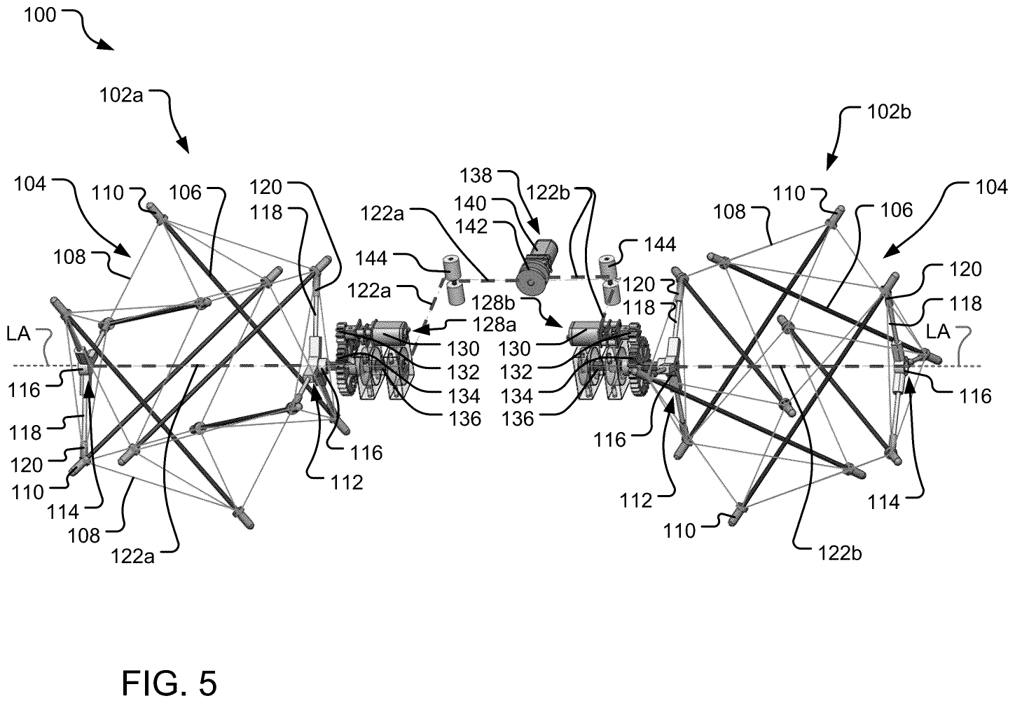

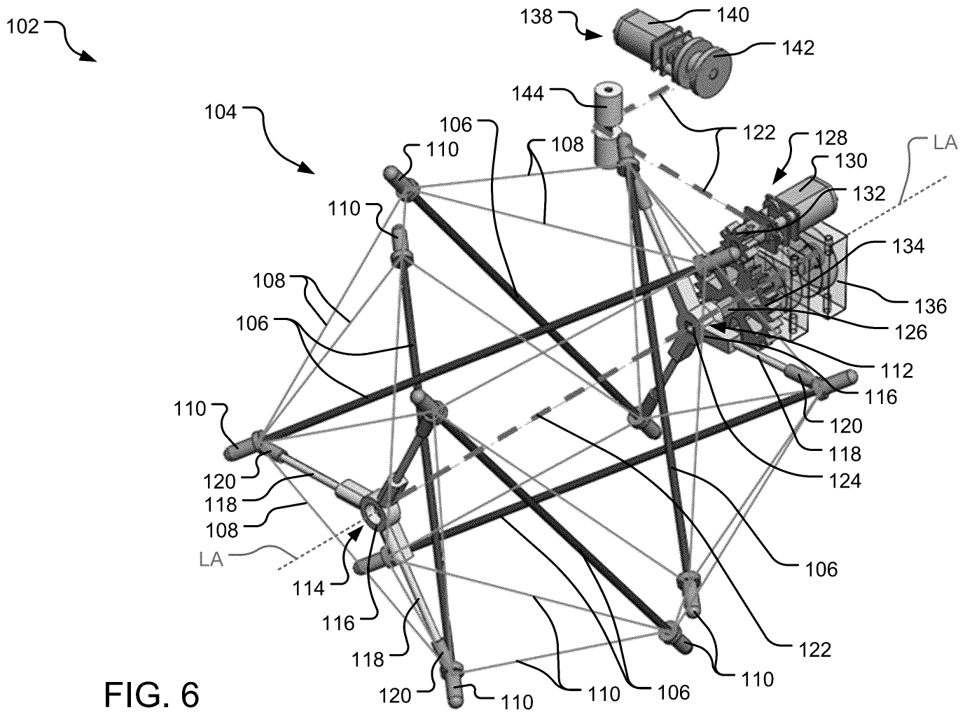

Turning to FIGS. 5-6, the tensegrity structure(s) 104 and the corresponding cable(s) 122 are illustrated (with the robot not illustrated). FIG. 5 illustrates a front view of two robotic wheels 102 (e.g., right robotic wheel 102a, left robotic wheel 102b), which each includes a tensegrity structure 104 and a corresponding cable 122 (e.g., cable 122a of the right robotic wheel 102a, cable 122b of the left robotic wheel 102b). FIG. 6 illustrates a perspective view of one robotic wheel 102, which includes a tensegrity structure 104 and a corresponding cable 122. Each cable 122 is configured to actuate (e.g., extend, retract), which causes cause the corresponding tensegrity structure 104 to expand or collapse. It should be noted that, although the cable 122 is illustrated by dashed lines in the figures to aid in visualization, the cable 122 is a continuous cable 122. In some embodiments, the cable 122 is a nylon cable.

The cable 122 is connected to the outer hub 114 (e.g., central portion 116) and extends through the inner hub 112 (e.g., central portion 116). The cable 122 is connected to the outer hub 114 (e.g., via a knot tied in the end of the cable 122, via a bearing) such that it can freely rotate. In some aspects, the central portion 116 of the outer hub 114 includes a pocket (e.g., round pocket) that receives and protects a knot that is tied in the end of the cable 122, such that the knot bears against an outer surface of the outer hub 114. In this manner, the tensegrity structure 104 can transition between and expanded state and a collapsed state, while the tensegrity structure 104 is wheeling about its longitudinal axis LA, without twisting the cable 122.

Between the outer hub 114 and the inner hub 112, the cable 122 extends through the tensegrity structure 104 (e.g., along the longitudinal axis LA of the tensegrity structure 104). The cable 122 is substantially parallel to the longitudinal axis LA, which is also the axis of rotation, of the tensegrity structure 104. In some embodiments, the cable 122 (e.g., portion of the cable 122 between the inner hub 112 and the outer hub 114) is coincident with the longitudinal axis LA of the tensegrity structure 104. In some aspects, the cable 122 between the inner hub 112 and outer hub 114 is substantially parallel to (and in some instances coincident with) the longitudinal axis LA of the tensegrity structure 104 when the tensegrity structure 104 is in an expanded state, when the tensegrity structure 104 is in a collapsed state, and when the tensegrity structure 104 is transitioning between an expanded state and a collapsed state.

Retracting the cable 122 causes the outer hub 114 move towards the inner hub 112 (e.g., laterally inward), which causes the tensegrity structure 104 to transition to a collapsed state (as illustrated as tensegrity structure 104a″ and tensegrity structure 104b″, for example, in FIG. 4). In other words, retracting the cable 122 deceases the width and increases the height of the tensegrity structure 104, as previously discussed. When the cable 122 is coincident with the longitudinal axis LA of the tensegrity structure 104, the tensegrity structure 104 collapses along its longitudinal axis LA (e.g., axis of rotation).

Extending the cable 122 causes the outer hub 114 to move away from the inner hub 112 (e.g., laterally outward), thereby causing the tensegrity structure 104 to transition to an expanded state (as illustrated as tensegrity structure 104a′ and tensegrity structure 104b′, for example, in FIG. 4). In other words, extending the cable 122 increases the width and decreases the height of the tensegrity structure 104, as previously discussed. When the cable 122 is coincident with the longitudinal axis LA of the tensegrity structure 104, the tensegrity structure 104 expands along its longitudinal axis LA (e.g., the axis of rotation).

The inner hub 112 includes a through hole 124 (e.g., at the center of the central portion 116) that slidably receives the cable 122 therethrough. As previously noted, the cable 122 is in fixed to the outer hub 114 and extends through the inner hub 112. In some aspects, the through hole 124 is substantially perpendicular to the inner plane (e.g., a vertical plane) defined by the inner hub 112. In some aspects, an longitudinal axis of the through hole 124 is coincident with the longitudinal axis LA of the tensegrity structure 104.

A hollow shaft 126 is coupled to and extends from the inner hub 112 away from the tensegrity structure 104 (e.g., laterally inward) and slidably receives the cable 122 therethrough. The longitudinal axis of the hollow shaft 126 is coincident with the longitudinal axis LA of the tensegrity structure 104. In some embodiments, the diameter of the through hole 124 corresponds to the diameter of the cable 122. In some embodiments, the hollow shaft is made of carbon fiber (i.e., hollow carbon fiber shaft). However, the shaft can be other lightweight materials.

Continuing with FIGS. 5-6, a driving mechanism 128 is configured to rotate each corresponding tensegrity structure 104, thereby causing the robot to move (e.g., translate, rotate) across a surface (e.g., the ground). The driving mechanism 128 can include a motor 130 (also referred to as a driving motor or a wheeling motor) and gears 132, 134. The motor 130 is coupled to the body 146 of the robot 100. In some embodiments the motor 130 is a micro metal gear motor (e.g., Pololu: 4794).

The motor 130 is configured to rotate, which causes the corresponding tensegrity structure 104 to rotate. The motor 130 drives a pinion gear 132, which drives a larger gear 134. In some examples, the pinion gear 132 is a small 3D-printed nylon pinon. In some examples, the pinion gear 132 and the larger gear 134 have a gear ratio of 3:1, which increases torque. The larger gear 134 is coupled to the hollow shaft 126, and the hollow shaft 126 is also coupled to the inner hub 112 of the tensegrity structure 104. In this manner, operating the motor 130 rotates the pinion gear 132, which correspondingly rotates the larger gear 134. This causes the hollow shaft 126 to rotate about its longitudinal axis, which rotates the tensegrity structure 104 about its longitudinal axis LA.

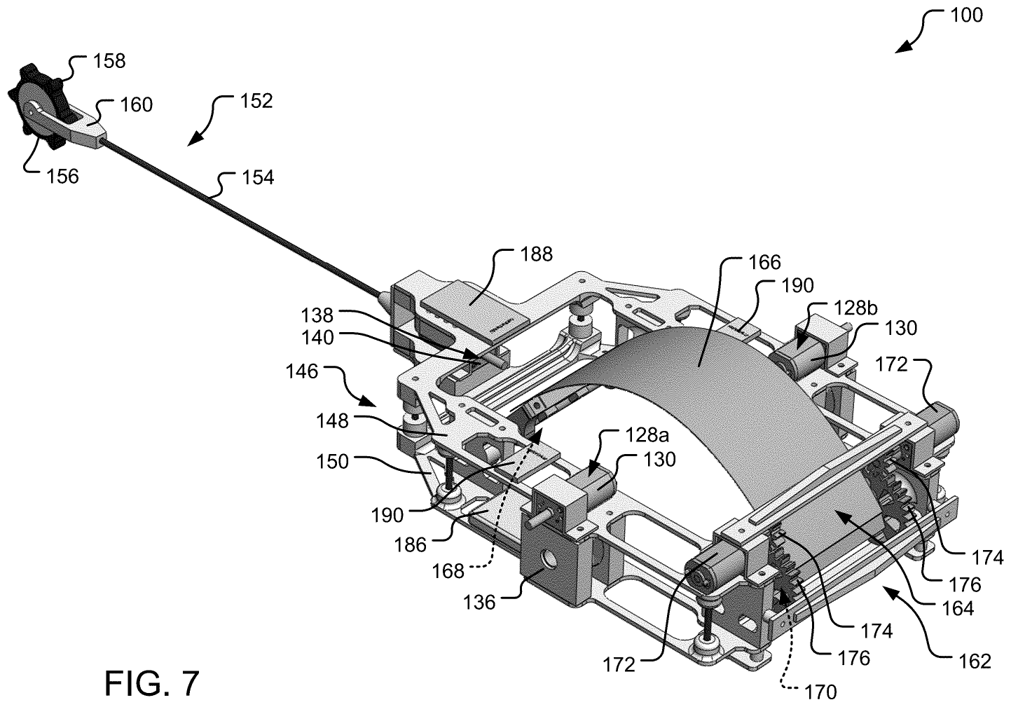

A bearing 136 receives the hollow shaft 126 and allows the hollow shaft 126 to rotate. The bearing 136 is coupled to the body 146 of the robot 100, as illustrated for example in FIG. 7. In other words, as illustrated in FIG. 6, the bearing 136 rotatably couples the hollow shaft 126 to the body 146 of the robot 100 and provides for smooth rotation of the hollow shaft 126. In some aspects, the bearing 136 is a miniature bearing (e.g., Uxcell: 626-2RS).

In some embodiments, as illustrated for example in FIG. 5, separate driving mechanisms 128 (e.g., right driving mechanism 128a, left driving mechanism 128b) correspond to each robotic wheel 102 (e.g., right robotic wheel 102a, left robotic wheel 102b). In this manner, the rotation of each robotic wheel 102 can be independently controlled. For example, rotating both the tensegrity structure 104 of the right robotic wheel 102a and the tensegrity structure 104 of the left robotic wheel 102b in the same direction can cause the robot 100 to move linearly (e.g., forward, backward). Rotating the tensegrity structure 104 of the right robotic wheel 102a and the tensegrity structure 104 of the left robotic wheel 102b in opposite directions can cause the robot to rotate.

Continuing with FIGS. 5-6, a collapsing mechanism 138 is configured to retract or extend the cable 122, thereby causing the tensegrity structure 104 to collapse or expand. The collapsing mechanism 138 can include a motor 140 (also referred to as a collapsing motor), which drives a pulley 142 that is in communication with the cable 122. That is, operating the motor 140 causes the pulley 142 to rotate, which correspondingly retracts or extends the cable 122. In some embodiments, the motor 140 and pulley 142 are disposed at the rear of the body 146 of the robot 100. In some aspects, the motor 140 is a micro metal gear motor (Pololu: 1595). In some aspects, the motor 140 is a DC motor.

As discussed previously, an outer end of the cable 122 is anchored to the center of the outer hub 114, while allowing for free rotation. That is, the tensegrity structure 104 can rotate without twisting the cable 122. From the outer end, the cable 122 runs through the open center of the tensegrity structure 104, through the through hole 124 of the inner hub 112, and through the hollow shaft 126. Then, the cable 122 continues around the body 146 of the robot 100 and is attached to the pulley 142 driven by the motor 140.

Rotating the pulley 142 is a first direction (e.g., clockwise, counterclockwise), retracts (or otherwise pulls) the cable 122 causing the tensegrity structure 104 to transition from an expanded state to a collapsed state. Rotating the pulley 142 in a second direction (opposite the first direction), extends (or otherwise releases) the cable 122 causing the tensegrity structure 104 to transition from a collapsed state to an expanded state.

In some embodiments, as illustrating for example in FIG. 5, a collapsing mechanism 138 (e.g., motor 140, pulley 142) is in communication with both the right cable 122a of the right robotic wheel 102a and the left cable 122b of the left robotic wheel 102b, such that the collapsing mechanism 138 can retract or extend the right cable 122a and the left cable 122b simultaneously. In other embodiments (not illustrated), two separate collapsing mechanisms 138 are in respective communication with the right cable 122a and the left cable 122b, such that the two collapsing mechanisms 138 can retract or extend the right cable 122a and the left cable 122b independently.

A cable roller 144, configured to support and guide the cable 122, can be disposed between the bearing 136 and the collapsing mechanism 138. In some embodiments, as illustrated for example in FIG. 5, each cable 122 (e.g., right cable 122a, left cable 122b) turns approximately 90-degrees after passing though the hollow shaft 126 (and the bearing 136). In this manner, the cable 122 runs towards the rear of the body 146 of the robot 100. The cable rollers 144 turn the cable 90-degrees such that the cable 122 runs in a lateral direction towards the collapsing mechanism 138 (e.g., motor 140, pulley 142).

Turning to FIG. 7, the disclosure now turns to body 146 and the tail 152 of the robot 100. FIG. 7 illustrates the body 146 and tail 152 of the robot 100 in a perspective view, according to embodiments of the present disclosure. The tensegrity structures (not shown) of the robot 100 are not illustrated in FIG. 7, so as to not obfuscate the view of the body 146.

The body 146 (also referred to as the frame) of the robot 100 houses all the electronics (e.g., battery 186, controller 188, motor drivers 190), motors (e.g., motors 130, motors 140, motors 172), and the jumping mechanism 162. In some embodiments, as illustrated for example in FIG. 7, the body 146 includes a top plate 148 and a bottom plate 150. In some examples, the top plate 148 and the bottom plate 150 are substantially parallel to each other. In some embodiments, each of the top plate 148 and bottom plate 150 are 3D printed. In some embodiments, each of the top plate 148 and bottom plate 150 are nylon. In some embodiments, one or more sensors, cameras, GPS units, and/or inertial measurement units are coupled to the body 146.

The body 146 houses the corresponding motors 130 of the driving mechanisms 128 (e.g., right driving mechanism 128a, left driving mechanism 128b). That is, the motors 130 are coupled to the body 146. As previously discussed, the motors 130 are configured to rotate each tensegrity structure (not illustrated in FIG. 7) to cause the robot 100 to move. In some embodiments, as illustrated for example in FIG. 7, the motors 130 are coupled to the top plate 148. In some embodiments, the motors 130 are disposed at opposite ends (e.g., right end, left end) of the body 146 of the robot 100.

The body 146 houses the motor 140 of the collapsing mechanism 138. That is, the motor 140 is coupled to the body 146. As previously discussed, the motor 140 is configured to cause the cable (not illustrated in FIG. 7) of each robotic wheel to extend and retract, thereby causing each tensegrity structure (not illustrated in FIG. 7) to transition between an expanded state and a collapsed state. In some embodiments, as illustrated for example in FIG. 7, the motor 140 is disposed at or near the back end of the body 146 of the robot 100.

The body 146 houses the motors 172 of the jumping mechanism 162. That is, the motors 172 are coupled to the body 146. As discussed below, the motors 172 are configured to cause the robot 100 to jump. In some embodiments, as illustrated for example in FIG. 7, the motors 172 are coupled to the top plate 148 of the body 146. In some embodiments, the motors 172 are disposed at or near the front end of the body 146 of the robot 100.

Turning now to the tail 152, in some embodiments, such as when the robot 100 includes two tensegrity structures 104 as wheels, the robot 100 includes tail 152. The tail 152 extends rearward from the body 146 of the robot 100. The tail 152 can aid the robot 100 in climbing (e.g., climbing over obstacles, climbing up slopes) by acting as a compliant arm to support the weight of the robot 100. The tail 152 can assist the jumping function of the robot 100 by ensuring that, when the robot 100 is at the apex of its jump, the robot 100 will not fall and flip backward. Upon reaching the jump apex, the robot 100 lands on its tail 152.

The tail 152 can include a rod 154 (also referred to as an elongate rod) that extends outward from the back of the body 146 of the robot 100. In some embodiments, the tail 152 (e.g., rod 154) is made from carbon fiber. In some embodiments, the length of the rod 154 is between approximately 200 mm and approximately 400 mm. In some examples, the length of the rod 154 is between approximately 250 mm and approximately 350 mm. In some examples, the length of the rod 154 is approximately 300 mm. In some embodiments, the diameter of the rod 154 is between approximately 1 mm and approximately 3 mm. In some examples, the diameter of the rod 154 is approximately 2 mm.

In some embodiments (not illustrated) the tail 152 does not include a wheel 156. For example, the back end of the rod 154 can be configured to slide across the ground as the robot locomotes. In some embodiments, as illustrated for example in FIG. 7, the tail 152 includes a wheel 156 (also referred to as a tail wheel). In some embodiments, a fork 160 is coupled to the rod 154 and is rotatably coupled to the wheel 156. The wheel 156 can be a passive wheel. In some embodiments, the diameter of the wheel 156 is between approximately 10 mm and approximately 30 mm. In some examples, the diameter of the wheel 156 is between approximately 15 mm and approximately 25 mm. In some examples, the diameter of the wheel 156 is approximately 20 mm.

In some embodiments, the wheel 156 includes spurs 158. The spurs 158 can reduce slipping on smooth surfaces, which enables the robot 100 to pivot about the wheel 156 and to fall forward from the full length (e.g., height) of the tail 152. In some embodiments, the wheel 156 includes between approximately four spurs 158 and approximately eight spurs 158. In some examples, the wheel 156 includes approximately six spurs 158.

Continuing with FIG. 7, the disclosure now turns to the jumping mechanism 162. FIG. 7 illustrates the jumping mechanism 162 of the robot 100, according to embodiments of the present disclosure. The jumping mechanism 162 can be disposed on the body 146 of the robot 100, as illustrated for example in FIGS. 1-3B. The jumping mechanism 162 is configured to cause the robot 100 to jump, or otherwise move at least in part in a direction substantially perpendicular to the surface on which the robot 100 is locomoting or otherwise traversing.

In some embodiments, the jumping mechanism 162 includes a bistable mechanism 164 that has two stable states to store energy and quickly release it. In some examples, the bistable mechanism can include at least one of bistable robotic catapult, a compact jumping robot using snap-through buckling with twisting, or a composite sheet metal bistable mechanism. The bistable mechanism 164 can provide advantages over other jumping mechanisms (e.g., spring-actuated jumping mechanisms) because it is lightweight and requires fewer components.

The bistable mechanism 164 can include a flexible plate 166. In some embodiments, the flexible plate 166 is woven carbon fiber. In some embodiments, the length of the flexible plate 166 is between approximately 125 mm and approximately 165 mm. In some examples, the length is approximately 145 mm. In some embodiments, the width of the flexible plate 166 is between approximately 35 mm and approximately 55 mm. In some examples, the width is approximately 45 mm. In some embodiments, the height (or thickness) of the flexible plate 166 is between approximately 0.2 mm and approximately 0.4 mm. In some examples, the height is approximately 0.3 mm.

The bistable mechanism 164 includes a passive rotational joint 168 (also referred to as a passive rotational pivot) and an active rotational joint 170 (also referred to as an active rotational pivot). The flexible plate 166 spans between a shaft (not shown) of the passive rotational joint 168 and a shaft (not shown) of the active rotational joint 170. That is, one end of the flexible plate 166 is coupled to the passive rotational joint 168 and the other end is coupled to the active rotational joint 170.

The active rotational joint 170 (i.e., shaft) is driven by opposing motors 172. In some embodiments the motors 172 are micro metal gear motors (e.g., Pololu: 1595). Each motor 172 is configured to actuate, drive, or otherwise rotate a pinion gear 174, which drives a larger gear 176. In some examples, the pinion gear 174 is a small 3D-printed nylon pinon. In some examples, the pinion gear 174 and the larger gear 176 have a gear ratio of 3:1. The larger gear 176 is coupled to a shaft (not shown), which extends perpendicular to the motors 172. In some aspects, the pair of motors 172 provide a symmetrical design for the robot 100 and increase the torque.

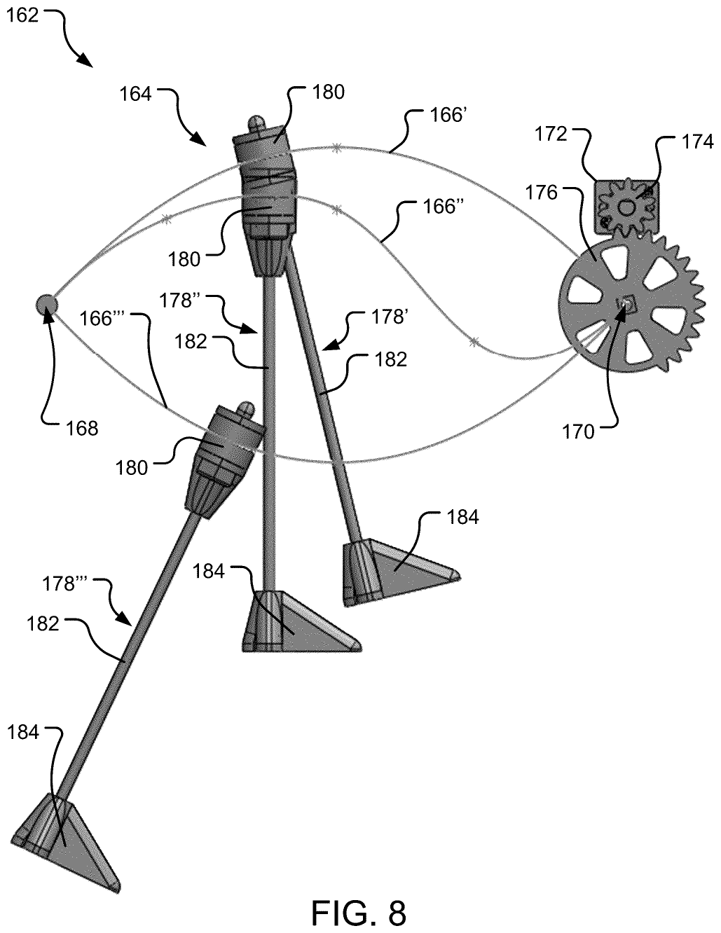

Turning now to FIG. 8, a schematic of the components and working principle of the jumping mechanism 162 is illustrated. More specifically, the flexible plate 166 (e.g., flexible plate 166′, flexible plate 166″, flexible plate 166′″) and the jumping foot 178 (e.g., jumping foot 178′, jumping foot″, jumping foot′″) are illustrated in three states. Flexible plate 166′ and jumping foot 178′ are illustrated in an initial state. Flexible plate 166″ and jumping foot 178″ are illustrated in a transitioning state. Flexible plate 166′″ and jumping foot 178′″ illustrated in a final state.

The jumping foot 178 extends from the flexible plate 166 and is configured to push against a surface (e.g., the ground) during the jumping process. Rotating the pinion gear 174 via the motor 172 correspondingly rotates larger gear 176. Rotating the larger gear 176 causes the shaft (not shown) of the active rotational joint 170 to rotate, which causes the end of the flexible plate 166 that is coupled to the active rotational joint 170 to rotate. When the end of the flexible plate 166 rotates, the flexible plate 166 (e.g., flexible plate 166′, flexible plate 166″, flexible plate 166′″) transitions between states.

The jumping foot 178 is coupled to the flexible plate 166 via a coupling mechanism 180. In some embodiments, the coupling mechanism 180 is configured to removably couple (e.g., a clamp) to the flexible plate 166 such that the position of the jumping foot 178 can be adjusted along the flexible plate 166. Adjusting the position of the jumping foot 178 along the flexible plate 166 can allow the robot 100 to take off at different angles to achieve different jumping performances.

A rod 182 extends outward (e.g., downward) from the coupling mechanism 180. A foot 184 is disposed at the end of the rod 182. In some aspects, the foot 184 is a 3D printed from a high-grip filament (e.g., Ninja-Flex Edge filament (83 A)) to enhance the friction between the foot 184 and a surface (e.g., the ground). In some aspects, a portion of the larger gear 176 does not include teeth, as illustrated for example in FIG. 8. The absence of teeth in this portion can ensure that the flexible plate 166 will not be damaged by over rotation of the active rotational joint 170.

From the initial state (e.g., flexible plate 166′, jumping foot 178′), the active rotational joint 170 begins to rotate the flexible plate 166′. In a transitioning state, (e.g., flexible plate 166″, jumping foot 178″) the flexible plate 166″ bends to store elastic energy as the active rotational joint 170 continues to rotate the flexible plate 166′. Eventually the flexible plate 166″ passes through a critical configuration, which causes the flexible plate 166″ to quickly snap through and release the stored energy. In the final state (e.g., flexible plate 166′″, jumping foot 178′″), the flexible plate 166′″ quickly snaps through, releasing the stored energy and causing the jumping foot 178′″ to rapidly push against the ground for jumping.

Returning to FIG. 7, the robot 100 can include an onboard embedded system, as illustrated for example in FIG. 7, which allows for untethered control of the robot 100. The onboard embedded system can control rotation of the tensegrity structures (not shown in FIG. 7), transitioning the tensegrity structures between an expanded state and a collapsed state, and actuation of the jumping mechanism 162. In some embodiments, the onboard embedded system includes small and lightweight components to maximize the jumping height of the robot 100.

A battery 186 is configured to power the robot 100. In some embodiments, the battery 186 is 7.4-V LiPo battery. In some embodiments, the battery 186 is removably coupled to the body 146 (e.g., bottom plate 150).

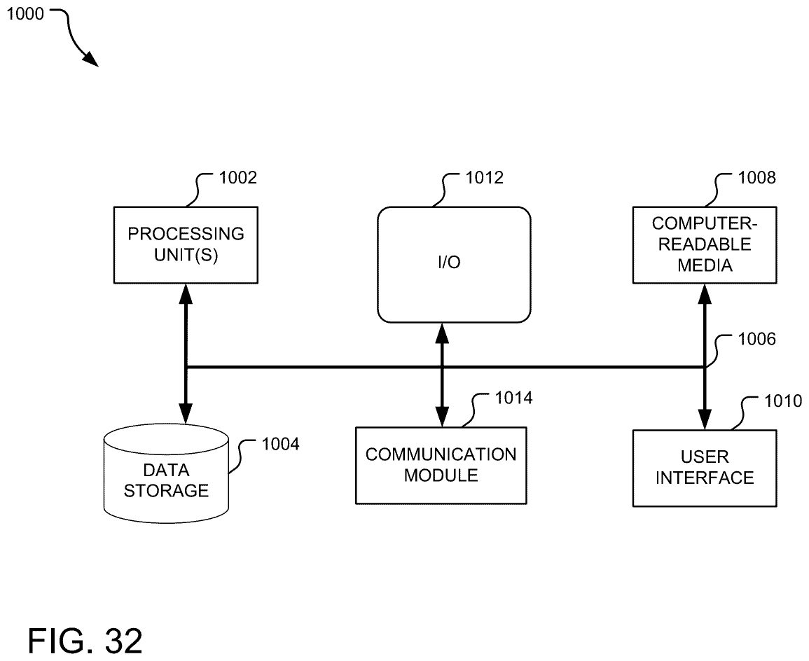

A controller 188 (e.g., microcontroller) is configured to control the robot 100. In some aspects, the controller 188 (as illustrated for example in FIGS. 3A-3B and FIG. 7) can include one or more same or similar components as the computing device 1000 (as illustrated for example in FIG. 32). In some embodiments, the controller 188 is an Arduino Pro Mini. One or more motor drivers 190 are configured to control the motors (e.g., two motors 130 of the driving mechanisms 128 for rotating the tensegrity structures 104 to drive the robot 100, motor 140 of the collapsing mechanism 138 to transition the tensegrity structures 104 of the robot 100, motors 172 of the jumping mechanism 162 to jump the robot 100). In some embodiments, the motor drivers 190 are DRV8835 dual motor drivers (e.g., Pololu item: 2135). In some embodiments, a receiver (not shown) is configured to allow control of the robot 100 via a remote. In some aspects, the receive is an infrared (IR) receiver (e.g., Uxcell: VS1838).

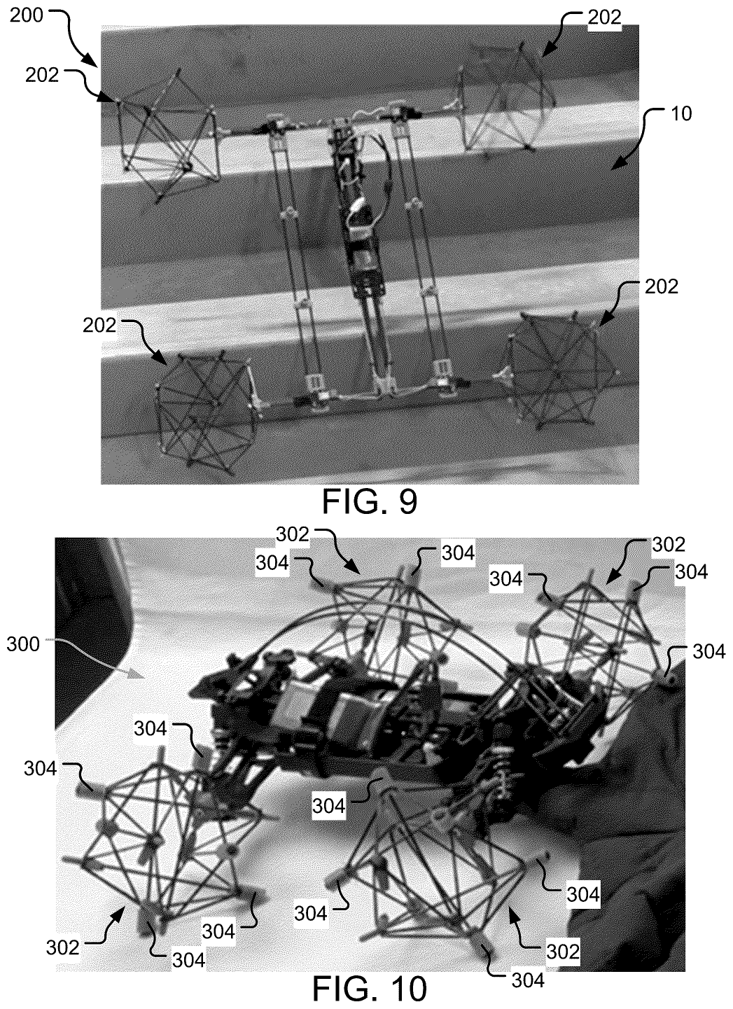

FIG. 9 illustrates a perspective view of a robot 200 that includes four tensegrity structures 202 as wheels, according to embodiments of the present disclosure. The robot 200 (as illustrated for example in FIG. 9) can include one or more same or similar features, components, or elements as the robot 100 (as illustrated for example in FIGS. 1-8 and as previously described). Similarly, each tensegrity structure 202 (as illustrated for example in FIG. 9) can include one or more same or similar features, components, or elements as the tensegrity structures 104 (as illustrated for example in FIGS. 1-6 and as previously described).

The tensegrity structures 202 used as wheels can allow the robot 200 to climb (or otherwise travel up) steps 10, such as stairs, because the tensegrity structure 202 can deform around each step 10, which allows the tensegrity structure 202 to push on the edge of each step 10 and move the robot 200 upward and forward. In some embodiments, the robot 200 is small and lightweight to facilitate travel up and down the steps 10. In some examples, each tensegrity structure 202 is 3D printed and light weight.

In some aspects, the robot 200 having four tensegrity structures 202 used as wheels can have the same or similar obstacle climbing advantages as a robot having two tensegrity structures used as wheels (such as robot 100 illustrated for example in FIGS. 1-8); however, it can provide certain advantages. For example, the robot 200 having four tensegrity structures 202 may not need a tail. As another example, the robot 200 can maintain the body of the robot further from the ground. In some aspects, the original wheels on four-wheeled robots can be replaced with tensegrity structures 202 to provide enhanced obstacle climbing and shock absorbing qualities.

FIG. 10 illustrates a perspective view of a robot 300 (e.g., a remote-controlled car) that includes four tensegrity structures 302 used as wheels, according to embodiments of the present disclosure. The robot 300 (as illustrated in FIG. 10) can include one or more same or similar features, components, or elements as the robot 100 (as illustrated for example in FIGS. 1-8 and as previously described). Similarly, each tensegrity structure 302 (as illustrated for example in FIG. 10) can include one or more same or similar features, components, or elements as the tensegrity structures 104 (as illustrated for example in FIGS. 1-6 and as previously described).

The tensegrity structures 302 used as wheels can allow the robot 300 to move (e.g., by rotating one or more of the tensegrity structures 302 about its longitudinal axis). In some embodiments, each tensegrity structure 302 is 3D printed from thermoplastic polyurethane (TPU). In some embodiments, each tensegrity structure 302 includes endcaps 304 at ends of the tensegrity structures 302. The endcaps 304 (as illustrated for example in FIG. 10) can include one or more same or similar features, components, or elements as the endcaps 110 (as illustrated for example in FIGS. 1-6 and as previously described). The endcaps 304 are configured to increase the friction between the tensegrity structures 302 and the ground. In some examples, the endcaps 304 are made of a polymer (e.g., rubber).

FIGS. 11A-11C illustrate a robot 400 that includes four tensegrity structures 402 used as wheels and configured to drive across land and water, according to embodiments of the present disclosure. The robot 400 (as illustrated in FIGS. 11A-11C) can include one or more same or similar features, components, or elements as the robot 100 (as illustrated for example in FIGS. 1-8 and as previously described). Similarly, each tensegrity structure 402 (as illustrated for example in FIGS. 11A-11C) can include one or more same or similar features, components, or elements as the tensegrity structures 104 (as illustrated for example in FIGS. 1-6 and as previously described).

Each tensegrity structure 402 is configured to provide for travel of the robot 400 across ground 11 (e.g., land) (as illustrated for example in FIG. 11A) and water 12 (as illustrated for example in FIG. 11B). Each tensegrity structure 402 (as illustrated for example in FIG. 11C) can include one or more paddles 404 coupled thereto. With the paddles 404 attached thereto, the tensegrity structure 402 can push water thereby allowing the robot 400 to drive and steer through the water 12. In this manner, the robot 400 has amphibious capabilities with the paddles 404 added to the tensegrity structures 402. In some examples, each tensegrity structure 402 includes three paddles 404 coupled thereto. In other examples, each tensegrity structure 402 can include less than three paddles 404 or more than three paddles 404.

In some embodiments, each paddle 404 includes a friction strip 406 (e.g., 3M grip tape) configured to increase friction between the tensegrity structure 402 and the ground when driving. In some embodiments, each tensegrity structure 402 includes endcaps 408 at ends of the tensegrity structures 402. The endcaps 408 (as illustrated for example in FIG. 11C) can include one or more same or similar features, components, or elements as the endcaps 110 (as illustrated for example in FIGS. 1-6 and as previously described). The endcaps 408 are configured to increase the friction between the tensegrity structures 402 and the ground 11. In some examples, the endcaps 408 are made of a polymer (e.g., rubber).

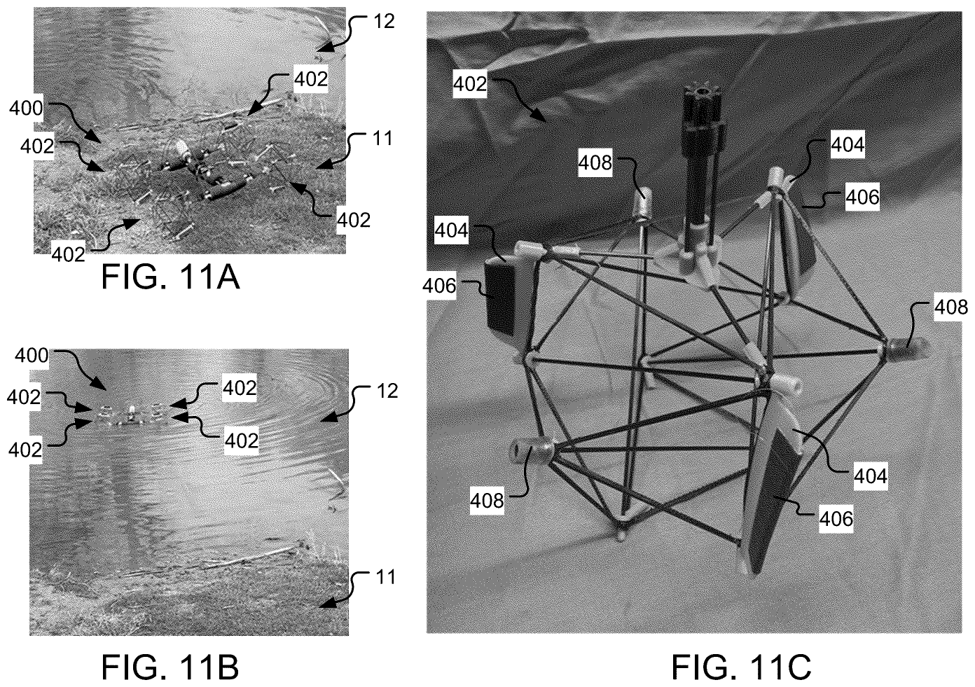

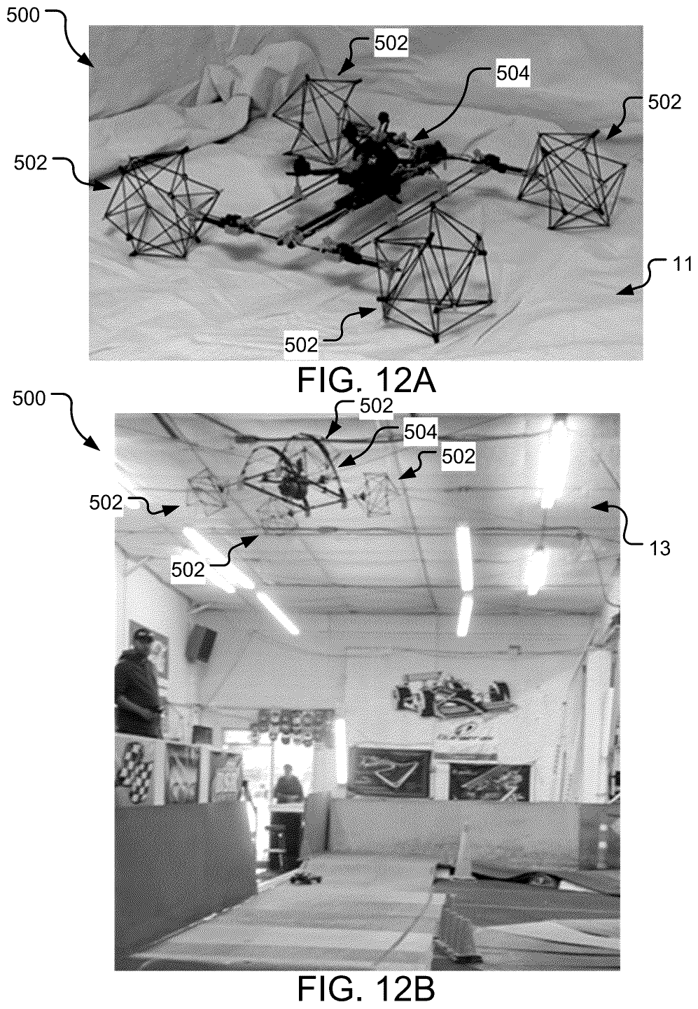

FIGS. 12A-12B_illustrate a robot 500 that includes a drone 504 (also referred to as an unmanned aerial vehicle) having tensegrity structures 502 used as wheels. The robot 500 (as illustrated in FIGS. 12A-12B) can include one or more same or similar features, components, or elements as the robot 100 (as illustrated for example in FIGS. 1-8 and as previously described). Similarly, each tensegrity structure 502 (as illustrated for example in FIGS. 12A-12B) can include one or more same or similar features, components, or elements as the tensegrity structures 104 (as illustrated for example in FIGS. 1-6 and as previously described).

The robot 500 can include a drone 504 such that the robot 500 can fly. In this manner, the robot 500 can travel across the ground 11 (as illustrated for example in FIG. 12A) of can fly through the air 13 (as illustrated for example in FIG. 12B). The tensegrity structures 502 are sturdy such that the tensegrity structures 502 can support the weight of the drone 504 as the robot 500 travels across the ground 11. The tensegrity structures 502 are lightweight such that the drone 504 can fly and maneuver through the air 13 even with the weight of the tensegrity structures 502.

### II. Robots Including One or More Tensegrity Structures in a Robotic Arm

Aspects of the present disclosure relate to a robot that includes one or more tensegrity structures within a robotic arm. Each of the tensegrity structures is configured to change shape, such that the robotic arm can be manipulated. The tensegrity structures are oriented in series between a first end and a second end opposite the first end. When the robotic arm (e.g., tensegrity structures) are fully extended and straightened, the tensegrity structures define a length of the robotic arm. In some examples, the robot includes an end effector, such as a robotic claw, at each end of the robotic arm. End effectors of robotic arms can be engaged to link multiple robotic arms together in series.

The robotic arm includes multiple cables connected to the first end and extending to the second end of the robotic arm. The cables can be evenly spaced around a longitudinal axis of the robotic arm. Each cable can be retracted inward towards the second end or extended outward away from the second end. In some instances, such as to contract or expand the robotic arm linearly, each of the cables can be extended or retracted at the same rate. In some instances, such as to cause the robotic arm to bend, the cables can be extended or retracted at different rates.

The robotic arm that includes tensegrity structures can provide several advantages over conventional robotic arms. For example, robotic arms including tensegrity structures can use less materials than conventional robotic arms of the same size. The reduction in materials can lead benefits such as cost savings and a reduced environmental impact. As another example, robotic arms including tensegrity structures are lightweight, making them easy to transport and deploy, which is in situations where weight and space are a concern (e.g., aerospace applications, military applications). For example, a lighter weight robotic arm can more easily be coupled to a drone (e.g., quadcopter) and used in aerial maneuvering.

As another example, robotic arms having tensegrity structures can collapse themselves in such a manner so as to fit into tighter spaces over conventional robotic arms. That is, the robotic arms having tensegrity structures can collapse axially or otherwise along the longitudinal axis. In this manner, the robotic arms having tensegrity structures can have a shorter length over conventional arms, which can allow them to enter certain spaces that conventional arms cannot.

As another example of benefits over conventional robotic arms, the robotic arms having tensegrity structures and end effectors disposed at each end of the robotic arm can be modular. Multiple robotic arms can be coupled together (via end effectors), thereby forming a longer robotic arm. Additionally, robotic arms with tensegrity structures and end effectors disposed at each end can be used for a variety of tasks, whereas conventional robotic arms may be industry or even task specific. For example, an end effector at one end of the robotic arm disclosed herein can be coupled to an object, such as a drone, such that the robotic arm extends away from the object and has an end effector opposite the object for performing tasks.

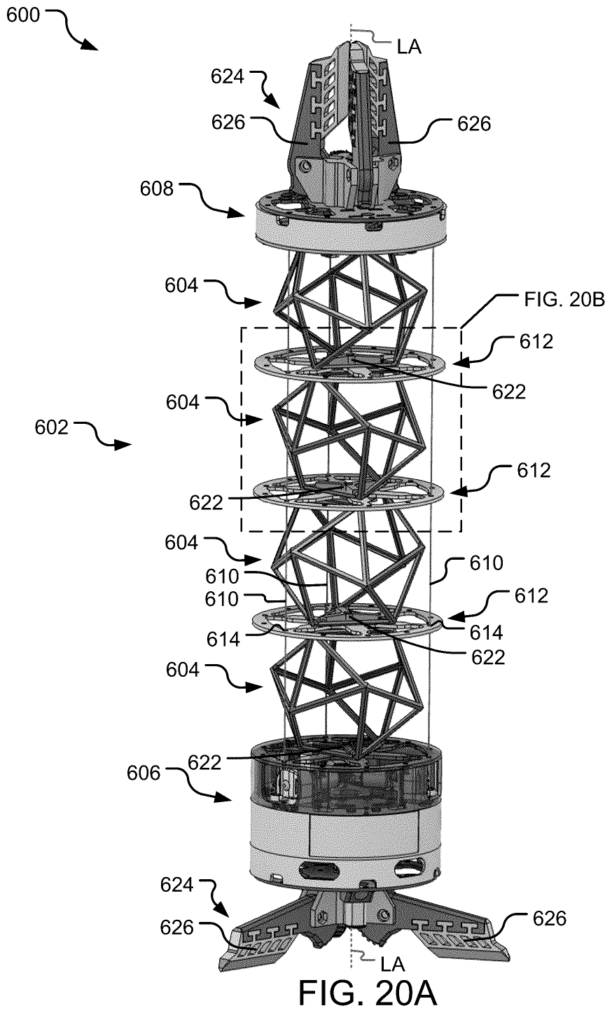

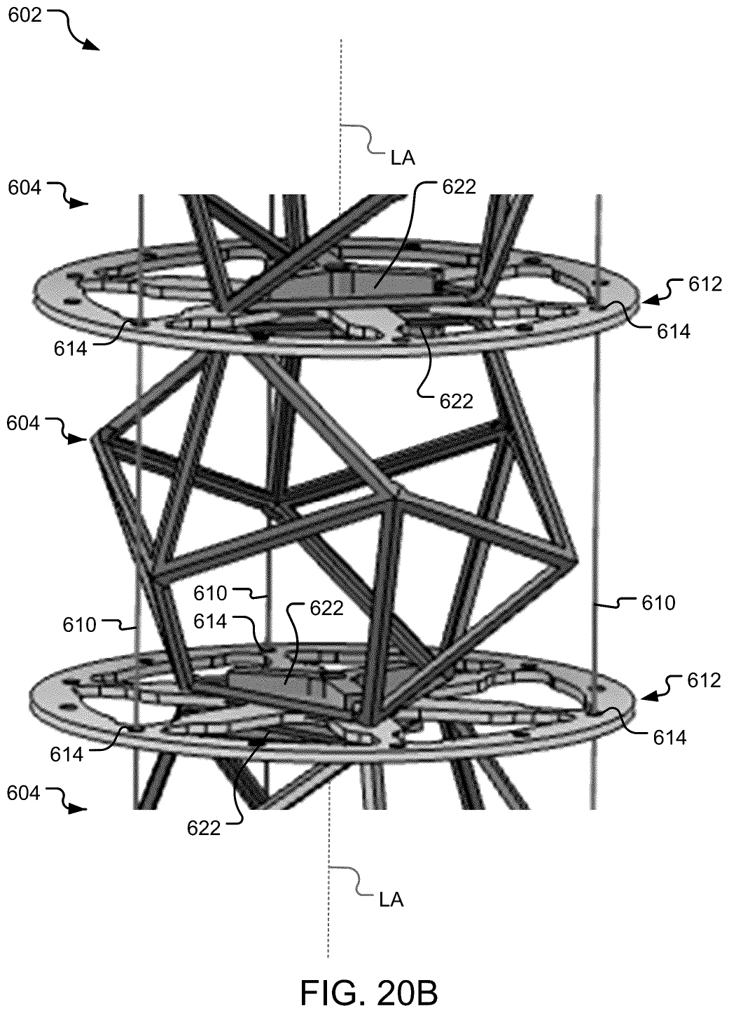

With reference to FIGS. 20A-20B, the present disclosure describes a robot 600 that includes a robotic arm 602. The robotic arm 602 includes one or more tensegrity structures 604 in series between a first base 606 and a second base 608 opposite the first base 606. One or more cables 610 extend between the first base 606 and the second base 608, and each cable 610 can be actuated (e.g., retracted, extended) to cause movement of the robotic arm 602. For example, the robotic arm 602 can expand (e.g., lengthen) and collapse (e.g., shorten). And the robotic arm 602 can straighten and bend (or otherwise curve). An end effector 624, which is configured to perform a task (e.g., gripping), can be disposed at each end of the robotic arm 602. FIG. 20A illustrates a perspective view of the robot 600 and FIG. 20B illustrates a detailed view (based on the cutaway illustrated on FIG. 20A) of a portion of the robotic arm 602 including tensegrity structures 604.

Beginning with the tensegrity structures 604, one or more tensegrity structures 604 are disposed between the first base 606 and the second base 608. Each tensegrity structure 604 (as illustrated for example in FIGS. 20A-20B) can include one or more same or similar features, components, or elements as the tensegrity structures 104 (as illustrated for example in FIGS. 1-6 and as previously described). For example, each tensegrity structure 604 can include multiple rods (also referred to as rigid rods) and multiple cables (also referred to as elastic cables). In this manner, each tensegrity structure 104 can elastically deform in response to external loads (e.g., retraction of one or more cables 610 towards the first base 606) and rebound after the external load is removed (e.g., extension of one or more cables 610 away from the first base 606).

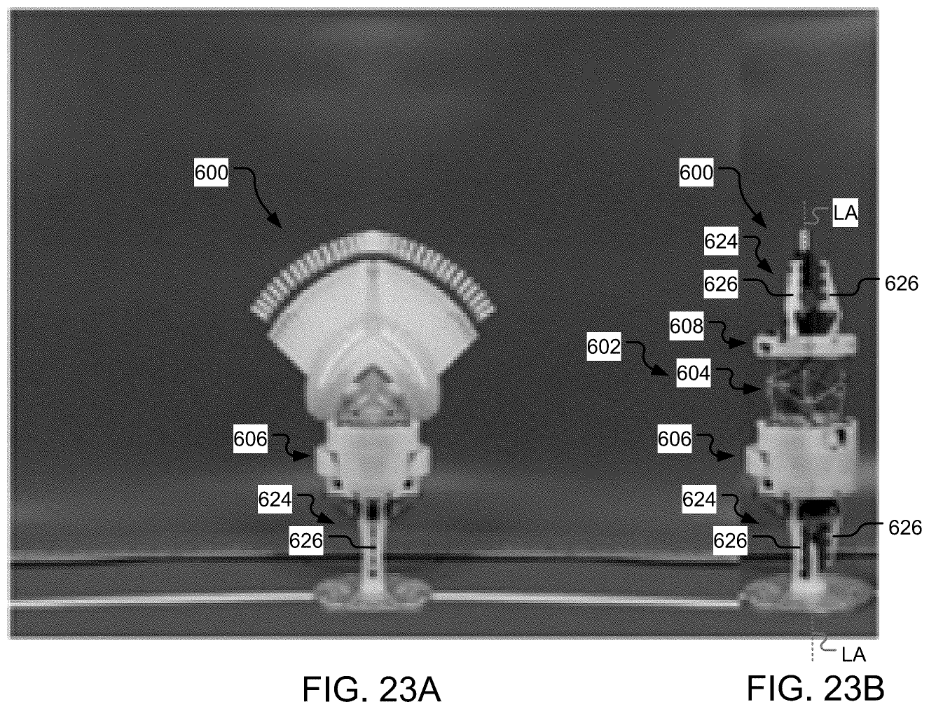

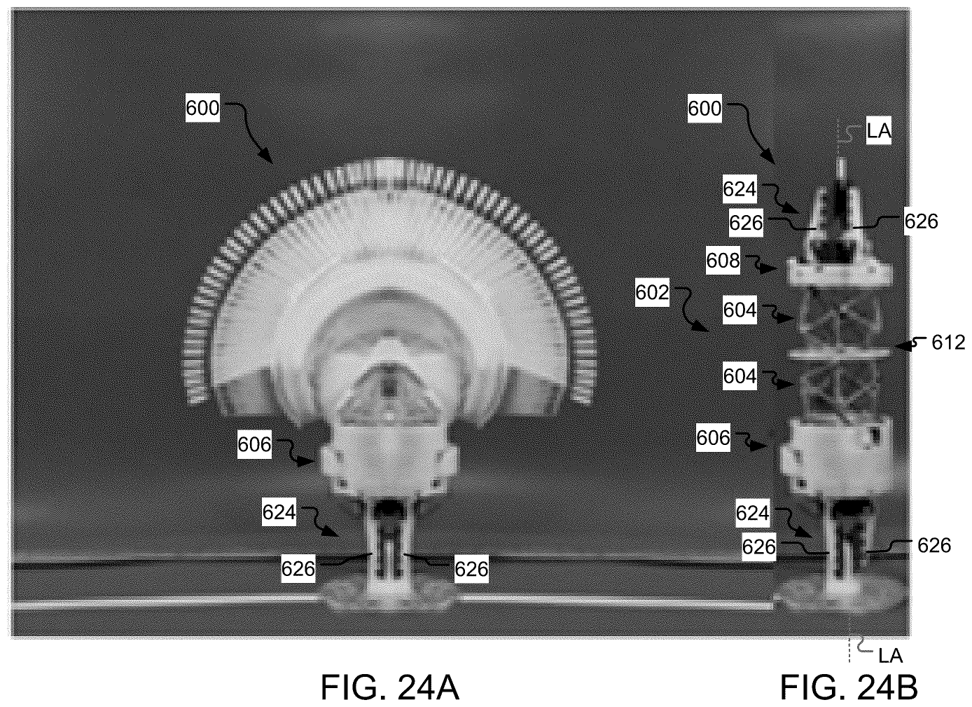

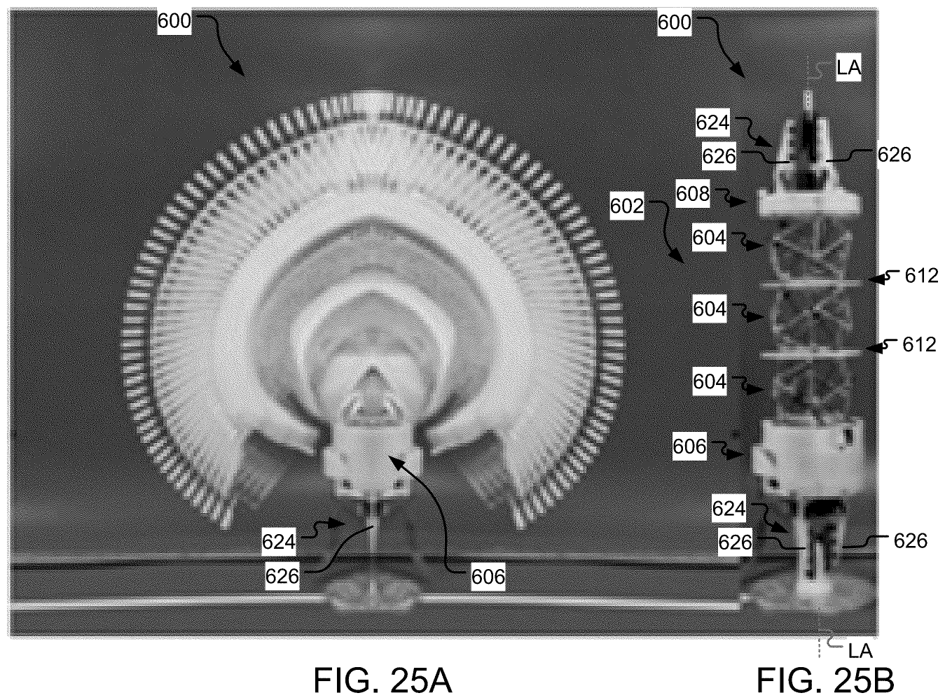

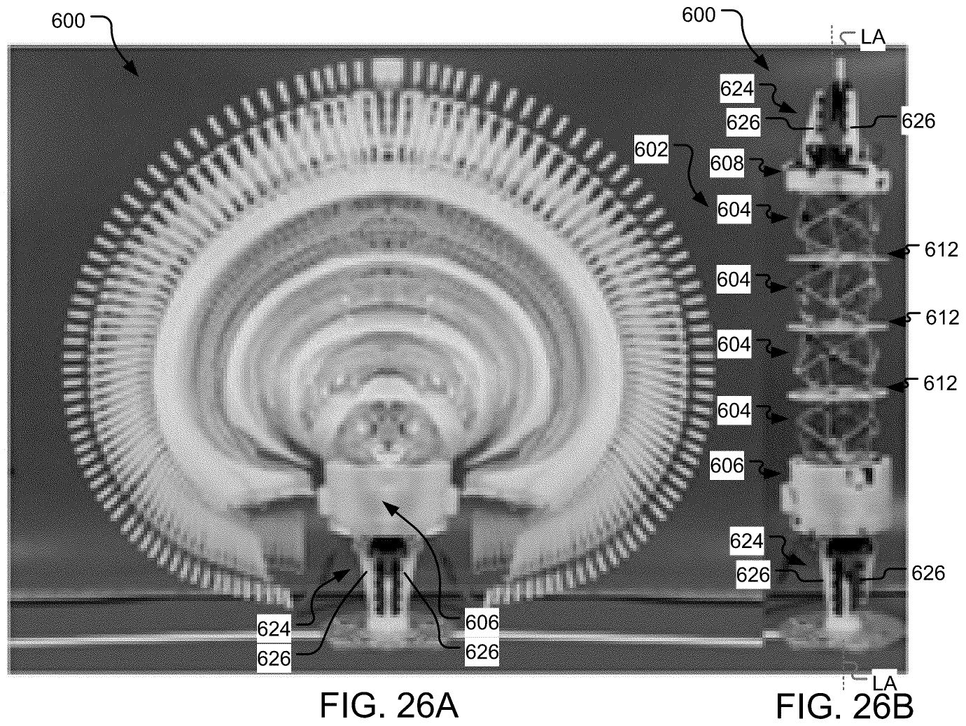

In some embodiments, as illustrated for example in FIGS. 23A-23B, the robotic arm 602 includes one tensegrity structure 604. In some embodiments, as illustrated for example in FIGS. 24A-24B, the robotic arm 602 includes two tensegrity structures 604. In some embodiments, as illustrated for example in FIGS. 25A-25B, the robotic arm 602 includes three tensegrity structures 604. In some embodiments, as illustrated for example in FIG. FIGS. 26A-26B, the robotic arm 602 includes four tensegrity structures 604. In some embodiments, the robotic arm 602 includes more than four tensegrity structures 604.

When the robotic arm 602 includes more than one tensegrity structure 604, the tensegrity structures 604 are disposed in series. The one or more tensegrity structures 604 define a longitudinal axis LA, as illustrated for example in FIG. 20A. Although the longitudinal axis LA of the of the robotic arm 602 (e.g., longitudinal axis of the tensegrity structures 604) is illustrated as substantially straight in FIG. 20A, the longitudinal axis follows the path of the robotic arm 602, which may be bent, curved, or otherwise manipulated. Therefore, when the robotic arm 602 is manipulated, the longitudinal axis LA varies with the centerline of the robotic arm 602.

In some embodiments, a hub 622 is disposed at opposing ends of each tensegrity structure 604. The hubs 622 (as illustrated for example in FIGS. 20A-20B) can include one or more same or similar features, components, or elements as the inner hub 112 and/or outer hub 114 (as illustrated for example in FIGS. 1-6 and as previously described). For example, each hub 622 can include a central portion, rods emanating from the central portion, and compliant connectors. In some aspects, the compliant connectors of the hub 622 are coupled to the ends of rigid rods of the tensegrity structure 604.

Each hub 622 defines a plane (e.g., a horizontal plane). In some aspects, the planes defined by each hub 622 are substantially parallel to each other when the longitudinal axis LA of the robotic arm 602 is substantially linear. In some aspects, the planes defined by each hub 622 are substantially perpendicular to the longitudinal axis LA of the robotic arm 602 when the longitudinal axis LA is substantially linear. In some aspects, the planes defined by each hub 622 are substantially perpendicular to the longitudinal axis LA of the robotic arm 602 when the longitudinal axis LA is substantially non-linear.

In some examples, the hubs 622 at the opposing ends of the robotic arm 602 are coupled to the first base 606 and the second base 608, respectively. In some examples, as illustrated for example in FIG. 20B, the hubs 622 of adjacent tensegrity structures 604 are coupled to opposing faces of a cable guide 612. In some examples (not illustrated), the hubs 622 of adjacent tensegrity structures 604 are coupled to each other. In this manner, the tensegrity structures 604 are disposed in series between the first base 606 and the second base 608.

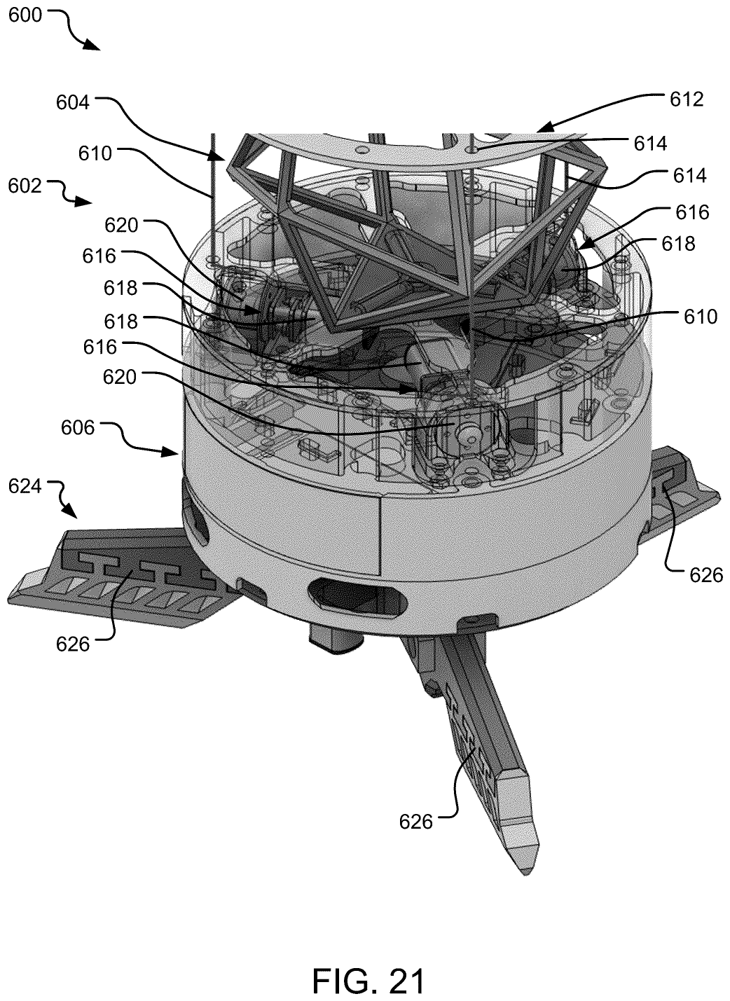

Turning to the first base 606 (also referred to as a proximal base), as illustrated in for example in FIG. 20A and FIG. 21, the first base 606 can include a housing. In some examples, the housing of the first base 606 encloses the one or more motors (not shown) that are configured to actuate the end effector 624 extending from the first base 606. In some examples, the housing of the first base 606 encloses the collapsing mechanism 616 (e.g., motor 618, pulley 620) configured to retract or extend a cable 610. The first base 606 defines a plane (e.g., a horizontal plane). In some aspects, the plane is substantially perpendicular to the longitudinal axis LA of the tensegrity structures 604.

The second base 608 (also referred to as a distal base), as illustrated for example in FIG. 20A, can include a housing. In some examples, the housing of the second base 608 encloses one or more motors (not shown) configured to actuate the end effector 624 extending from the second base 608. The second base 608 defines a plane (e.g., a horizontal plane). In some aspects, the plane is substantially perpendicular to the longitudinal axis LA of the tensegrity structures 604. In some aspects, the plane defined by the first base 606 is substantially parallel to the plane defined by the second base 608 when the longitudinal axis LA of the robotic arm 602 is substantially linear.

Turning to the cables 610, and continuing with FIGS. 20A-21, one or more cables 610 extend between the first base 606 and the second base 608. Each cable 610 (as illustrated for example in FIGS. 20A-20B) can include one or more same or similar features, components, or elements as the cable 122 (as illustrated for example in FIGS. 1-6 and as previously described). For example, in some embodiments each cable 610 is a nylon cable. In some aspects, each cable 610 is substantially parallel to the longitudinal axis LA of the robotic arm 602.

Each cable 610 is fixed (e.g., coupled) to the second base 608. And each cable 610 can be retracted inward (e.g., toward the first base 606) or extended outward (e.g., away from the first base 606). In some aspects, such as when the longitudinal axis LA of the robotic arm 602 is substantially linear, each cable 610 is substantially parallel to the longitudinal axis LA. In some examples, the robotic arm 602 includes three cables 610. In other examples, the robotic arm 602 includes more than three cables 610.

In some examples, the cables 610 are equally spaced along circumference defined radially outward from the longitudinal axis LA of the robotic arm 602. When the robotic arm 602 includes three cables 610 equally spaced around a circumference, as illustrated for example in FIGS. 20A-20B, a pair of adjacent cables 610 defines an angle of approximately 120-degrees with respect to each other. When the robotic arm 602 includes four cables 610 equally spaced around a circumference, a pair of adjacent cables 610 defines an angle of approximately 90-degrees with respect to each other.

One or more cable guides 612 extend radially outward from the longitudinal axis LA of the robotic arm 602. Each cable guide 612 includes one or more apertures 614, as illustrated for example in FIG. 20B. Each aperture 614 configured to receive a corresponding cable 610 therethrough. That is, each cable 610 extends through the corresponding aperture 614 of each cable guide 612. And each cable 610 can freely slide through each aperture 614 as the cable 610 is retracted or extended. In some embodiments, a cable guide 612 extends radially outward from the interface between each abutting tensegrity structure 604. In some examples, the hubs 622 of adjacent tensegrity structures 604 can be coupled to opposing faces of the cable guide 612.

The aperture 614 of each cable guide 612 maintains each cable 610 radially outside of each of the tensegrity structures 604. In other words, the cable guides 612 prevent the cables 610 from contacting the tensegrity structures 604 of the robotic arm 602 as the robotic arm 602 moves (e.g., as one or more cables 610 are extended or retracted). In some aspects, the aperture 614 of each cable guide 612 maintains each cable 610 substantially parallel to the longitudinal axis LA of the robotic arm 602 as the robotic arm is manipulated.

Each cable guide 612 defines a plane (e.g., a horizontal plane). In some aspects, the planes defined by each cable guide 612 are substantially parallel to each other when the longitudinal axis LA of the robotic arm 602 is substantially linear. In some aspects, the planes defined by each cable guide 612 are substantially perpendicular to the longitudinal axis LA of the robotic arm 602 when the longitudinal axis LA is substantially linear. In some aspects, the planes defined by each cable guide 612 are substantially perpendicular to the longitudinal axis LA of the robotic arm 602 when the longitudinal axis LA is substantially non-linear.

Turning to FIG. 21, a collapsing mechanism 616 is configured to retract or extend each cable 610, thereby causing corresponding movement of the robotic arm 602. Each collapsing mechanism 616 is disposed at the first base 606. In some embodiments, each collapsing mechanism 616 is disposed within a housing of the first base 606. Each cable 610 (e.g., three cables) includes its own independent collapsing mechanism 616 (e.g., three collapsing mechanisms). In this manner, each cable 610 can be independently retracted or extended. FIG. 21 illustrates a perspective view of the first base 606 including collapsing mechanisms 616 disposed therein.

The collapsing mechanism 616 can include a motor 618 (also referred to as a collapsing motor), which drives a pulley 620 that is in communication with the cable 610. That is, operating the motor 618 causes the pulley 620 to rotate, which correspondingly retracts or extends the cable 610. In some embodiments, the motor 618 and pulley 620 are disposed within the first base 606. In some aspects, each motor 618 is a micro gear motor. In some aspects, each motor 618 is a micro metal gear motor (Pololu: 1595). In some aspects, each motor 618 is a DC motor.

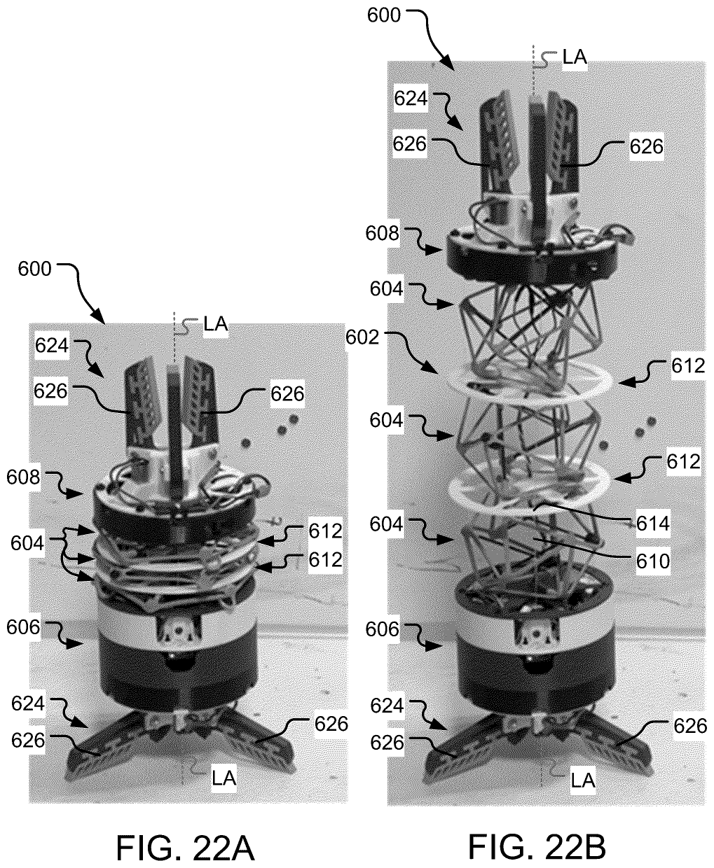

In some aspects, extending or retracting the cables 610 causes linear movement (as illustrated for example in FIGS. 22A-22B) of the robotic arm 602. FIG. 22A illustrates a perspective view of a robotic arm 602 in a collapsed state and FIG. 22B illustrates a perspective view of the robotic arm 602 in an expanded state. Each of the cables 610 can be extended, such that the robotic arm 602 transitions from a collapsed state (as illustrated in FIG. 22A) to an expanded state (as illustrated in FIG. 22B). Each of the cables 610 can be retracted, such that the robotic arm 602 transitions from an expanded state (as illustrated in FIG. 22B) to a collapsed state (as illustrated in FIG. 22A).

In some aspects, extending or retracting at least one cable 610 causes rotational movement (as illustrated for example in FIGS. 23A-26D) of the robotic arm 602. FIGS. 23A-23B illustrate side views of a robotic arm 602 including one tensegrity structure 604 (as illustrated in FIG. 23B) and the corresponding robotic arm 602 range of motion (as illustrated in FIG. 23A). FIGS. 24A-24B illustrate side views of a robotic arm 602 including two tensegrity structures 604 (as illustrated in FIG. 24B) and the corresponding robotic arm 602 range of motion (as illustrated in FIG. 24A). FIGS. 25A-25B illustrate side views of a robotic arm 602 including three tensegrity structures 604 (as illustrated in FIG. 25B) and the corresponding robotic arm 602 range of motion (as illustrated in FIG. 25A). FIGS. 26A-26B illustrate side views of a robotic arm 602 including four tensegrity structures 604 (as illustrated in FIG. 26B) and the corresponding robotic arm 602 range of motion (as illustrated in FIG. 26A). FIGS. 23A-26D are side views, such that the ranges of motion in FIGS. 23A, 24A, 25A, and 26A are illustrated in a plane (i.e., 2D). However, it should be noted that the illustrated range of motion applies to 3D.

Returning to FIG. 20A, each cable 610 defines a length between the first base 606 and the second base 608. In some aspects, the robotic arm 602 can be straightened by causing (e.g., via retraction or extension of a first cable 610) the length of a first cable 610 to become substantially equal to the length of each of the other cables 610. That is, the longitudinal axis LA of the robotic arm 602 is substantially linear (as illustrated for example in FIGS. 22A-22B) when the length of each cable 610 are substantially the same. In some aspects, the robotic arm 602 can be bent, curved, or otherwise manipulated by causing (e.g., via retraction or extension of a first cable 610) the length of at least a first cable 610 to become substantially unequal than the length of at least a second cable 610. That is, the longitudinal axis LA of the robotic arm 602 is substantially non-linear (as illustrated for example in FIGS. 23A-26B) when the length of at least one cable 610 is different than the length of another cable 610.

Each cable 610 can be retracted or extended at a rate. In some aspects, the robotic arm 602 can be extended or collapsed linearly (e.g., via retraction or extension of each cable 610) when each cable 610 is retracted or extended at the same rate. For example, the longitudinal axis LA of the robotic arm 602 can remain substantially linear as the robotic arm 602 transitions between an expanded state and a collapsed state, as illustrated for example in FIGS. 22A-22B, when the rate of corresponding extension or retraction of each cable 610 is substantially the same. In some aspects, the robotic arm 602 can be bent, curved, or otherwise manipulated (e.g., via retraction or extension of a first cable 610) by causing at least a first cable 610 to be retracted or extended at a rate that is different than the rate of retraction or extension at least a second cable 610.

An end effector 624 can be disposed at one or more ends of the robotic arm 602. In some embodiments, an end effector 624 extends from the first base 606. In some aspects, the end effector 624 extends substantially perpendicular to the first plane defined by the first base 606. In some aspects, the end effector 624 extends substantially parallel to the longitudinal axis LA of the robotic arm 602. In some embodiments, an end effector 624 extends from the second base 608. In some aspects, the end effector 624 extends substantially perpendicular to the second plane defined by the second base 608. In some aspects, the end effector 624 extends substantially parallel to the longitudinal axis LA of the robotic arm 602. In some embodiments, each end effector 624 includes one or more jaws 626. However, other end effectors 624, such as, for example, a magnet, are envisioned.

In some embodiments, each end effector 624 includes one or more jaws 626 (also referred to as claws). Each end effector 624 includes one or more motors (not illustrated) configured to actuate each of the one or more of the jaws 626. In this manner, the jaws 626 can transition between a closed configuration (as illustrated for example by the top end effector 624 in FIG. 20A) and an open configuration (as illustrated for example by the bottom end effector 624 of FIG. 20A).

In some embodiments, one or more controllers (e.g., microcontroller) (not shown) can control the robot 600. In some aspects, the controller 188 can include one or more same or similar components as the computing device 1000 (as illustrated for example in FIG. 32). In some embodiments, one or more controllers are be disposed in the housing of the first base 606. The controllers can be configured to actuate each collapsing mechanism 616 (e.g., retract or extend each cable 610) and/or actuate the end effector 624 extending from the first base 606 (e.g., open or close the jaws 626). One or more controllers can be disposed in the housing of the second base 608, and the controllers can be configured to actuate the end effector 624 extending from the second base 608 (e.g., open or close the jaws 626).

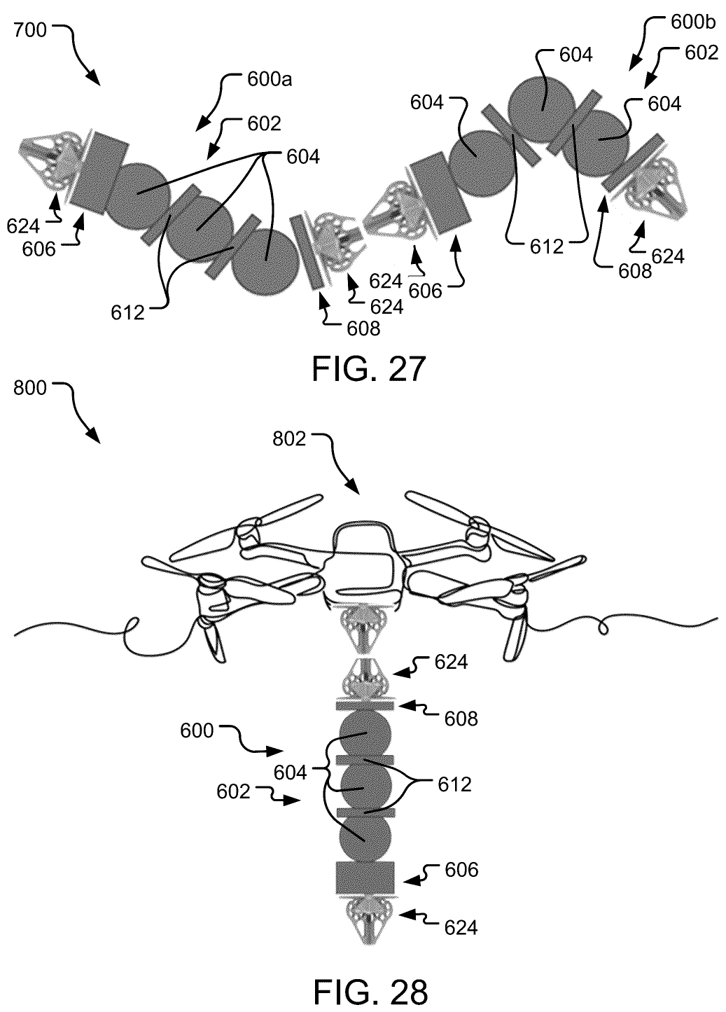

FIG. 27 illustrates a side view of a robot 700 that includes two tensegrity robots 600 (e.g., first robot 600a, second robot 600b) coupled together in series, according to embodiments of the present disclosure. Each of the first robot 600a and second robot 600b (as illustrated for example in FIG. 27) can include one or more same or similar features, components, or elements as the robot 600 (as illustrated for example in FIGS. 20-26B and as previously described).

An end effector 624 (e.g., jaws) of a first robot 600a can be coupled to an end effector 624 of a second robot 600b to join the first robot 600a and the second robot 600b together in series. In this manner, the first robot 600a and second robot 600b are modular in that they can be joined to form a longer robot.

Multiple robots (e.g., first robot 600a, second robot 600b) joined together in series can move with snake-like locomotion (e.g., slithering). In some aspects, the multiple robots joined together can be used to travel in water (e.g., across the surface of the water, underwater), such as with snake-like locomotion. Each individual robot (e.g., first robot 600a) can move with undulation locomotion.

FIG. 28 illustrates a robot 800 that includes a drone 802 (also referred to as an unmanned aerial vehicle) and a robot 600, according to embodiments of the present disclosure. The robot 600 (as illustrated for example in FIG. 28) can include one or more same or similar features, components, or elements as the robot 600 (as illustrated for example in FIGS. 20-26B and as previously described) or the first robot 600a or second robot 600b (as illustrated for example in FIG. 27).

The drone 802 (e.g., quadcopter) can fly, such that the robot 600 can travel through the air when coupled thereto. In other words, the robot 800 can perform aerial manipulation. The robot 600 is lightweight such that the drone 802 can fly and maneuver through the air even with the weight of the robot 600.

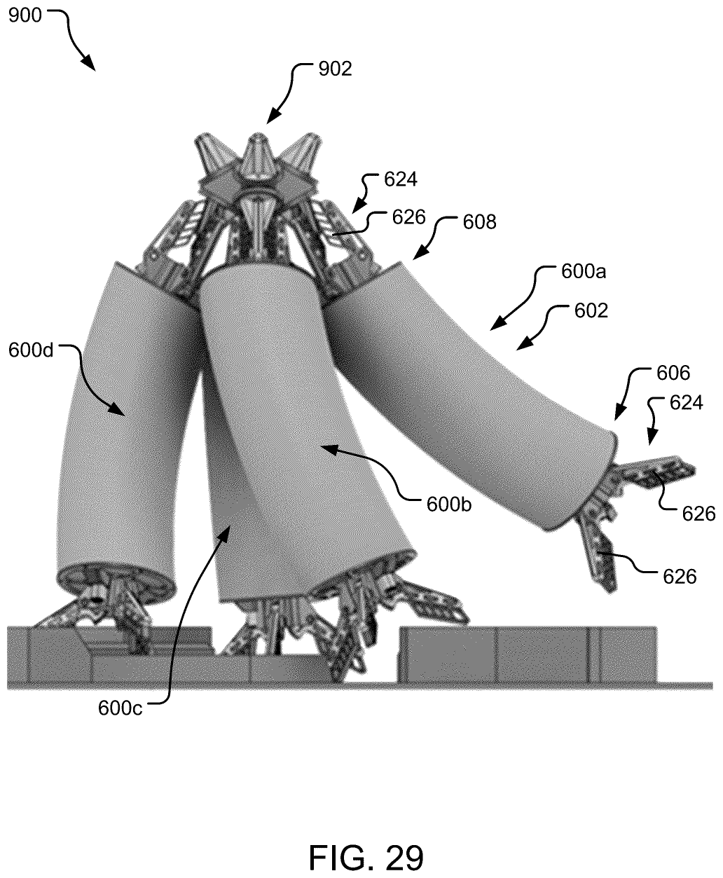

FIG. 29 illustrates a perspective view of a robot 900 that includes four tensegrity robots 600 (e.g., first robot 600a, second robot 600b, third robot 600c, fourth robot 600d) coupled to a common object 902 and each extending therefrom, according to embodiments of the present disclosure. Each of the first robot 600a, second robot 600b, third robot 600c, and fourth robot 600d (as illustrated for example in FIG. 29) can include one or more same or similar features, components, or elements as the robot 600 (as illustrated for example in FIGS. 20-26B and as previously described).

In FIG. 29, the first robot 600a, second robot 600b, third robot 600c, and fourth robot 600d are each illustrated with a cover over the tensegrity structures disposed therein. In some embodiments, the covers can be removed. It should be noted that the same or similar covers can be added to robots previously described in this disclosure.

In one example, each of the first robot 600a, second robot 600b, third robot 600c, and fourth robot 600d function as an operable leg of the robot 900, such that the robot 900 can walk. The object 902 can include extensions extending radially outward in multiple directions such that each robot 600 (e.g., jaws) can readily couple thereto.

FIG. 32 illustrates a suitable computing and networking environment 1000 (e.g., computing device 1000), according to some embodiments of the present disclosure, that can be part of or useable with the system described herein. In other words, the computing device 1000 can be used to implement various aspects of the present disclosure described herein. In some embodiments, the robot 100 (as illustrated for example in FIGS. 1-8), the robot 200 (as illustrated for example in FIG. 9), the robot 300 (as illustrated for example in FIG. 10), the robot 400 (as illustrated for example in FIGS. 11A-11C), the robot 500 (as illustrated for example in FIGS. 12A-12B), the robot 600 (as illustrated for example in FIGS. 20A-26B), the robot 700 (as illustrated for example in FIG. 27), the robot 800 (as illustrated for example in FIG. 28), and/or the robot 900 (as illustrated for example in FIG. 29) can be operated with (or otherwise on) a computing device 1000 (as illustrated for example in FIG. 32).

As illustrated, the computing and networking environment 1000 includes a general purpose computing device 1000, although it is contemplated that the networking environment 1000 may include other computing systems, such as smart phones, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments that include any of the above computing systems or devices, and the like.

Components of the computer 1000 may include various hardware components, such as a processing unit 1002, a data storage 1004 (e.g., a system memory), and a system bus 1006 that couples various system components of the computer 1000 to the processing unit 1002. The system bus 1006 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 1000 may further include a variety of computer-readable media 1008 that includes removable/non-removable media and volatile/nonvolatile media, but excludes transitory propagated signals. Computer-readable media 1008 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computer 1000. Communication media includes computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The data storage or system memory 1004 includes computer storage media in the form of volatile/nonvolatile memory such as read only memory (ROM) and random access memory (RAM). A basic input/output system (BIOS), containing the basic routines that help to transfer information between elements within the computer 1000 (e.g., during start-up) is typically stored in ROM. RAM typically contains data and/or program modules that are immediately accessible to and/or presently being operated on by processing unit 1002. For example, in one embodiment, data storage 1004 holds an operating system, application programs, and other program modules and program data.

Data storage 1004 may also include other removable/non-removable, volatile/nonvolatile computer storage media. For example, data storage 1004 may be: a hard disk drive that reads from or writes to non-removable, nonvolatile magnetic media; a magnetic disk drive that reads from or writes to a removable, nonvolatile magnetic disk; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media, described above and illustrated in FIG. 32, provide storage of computer-readable instructions, data structures, program modules and other data for the computer 1000.

A user may enter commands and information through a user interface 1010 or other input devices such as a tablet, electronic digitizer, a microphone, keyboard, and/or pointing device, commonly referred to as mouse, trackball or touch pad. The commands and information may be for actuating a driving mechanism 128, actuating a collapsing mechanism 138, and/or actuating a jumping mechanism of robot 100 (as illustrated for example in FIGS. 1-8) or for actuating a collapsing mechanism 616 and/or actuating one or more end effectors 624 (e.g., jaws 626) of robot 600 (as illustrated for example in FIGS. 20A-26D). Other input devices may include a joystick, game pad, satellite dish, scanner, or the like. Additionally, voice inputs, gesture inputs (e.g., via hands or fingers), or other natural user interfaces may also be used with the appropriate input devices, such as a microphone, camera, tablet, touch pad, glove, or other sensor. These and other input devices are often connected to the processing unit 1002 through a user interface 1010 that is coupled to the system bus 1006, but may be connected by other interface and bus structures, such as a parallel port, game port or a universal serial bus (USB).

The computer system 1000 can include one or more ports, such as an input/output (I/O) port 1012. The I/O port 1012 can be connected to an I/O device, or other device, by which information is input to or output from the computing system 1000. Such I/O devices may include, without limitation, one or more input devices, output devices, and/or environment transducer devices. In some embodiments, the I/O port 1012 is in communication with motors 130 of the driving mechanisms 128, motor 140 of the collapsing mechanism 138, motors 172 of the jumping mechanism 162, and/or one or more motor drivers 190 (as illustrated for example in FIGS. 1-8). In some embodiments, the I/O port 1012 is in communication with motors 618 of the collapsing mechanisms 616 and/or motors (not shown) of the end effectors 624.

The computer 1000 may operate in a networked or cloud-computing environment using a communication module 1014 (e.g., logical connections of a network interface or adapter) to one or more remote devices, such as a remote computer. The remote computer may be a personal computer, a server, a router, a network PC, a peer device or other common network node, and typically includes many or all of the elements described above relative to the computer 1000. The logical connections depicted in FIG. 32 include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computer 1000 may be connected to a public and/or private network through the communication module 1014. In such embodiments, a modem or other means for establishing communications over the network is connected to the system bus 1006 via the communication module 1014 or other appropriate mechanism. A wireless networking component including an interface and antenna may be coupled through a suitable device such as an access point or peer computer to a network. In a networked environment, program modules depicted relative to the computer 1000, or portions thereof, may be stored in the remote memory storage device.

### Examples

The materials, methods, and embodiments described herein are further defined in the following Examples. Certain embodiments are defined in the Examples herein. It should be understood that these Examples, while indicating certain embodiments, are given by way of illustration only. From the disclosure herein and these Examples, one skilled in the art can ascertain the essential characteristics of this invention, and without departing from the spirit and scope thereof, can make various changes and modifications of the invention to adapt it to various usages and conditions.

### Example 1—Analysis of Force Required to Collapse a Tensegrity Wheel

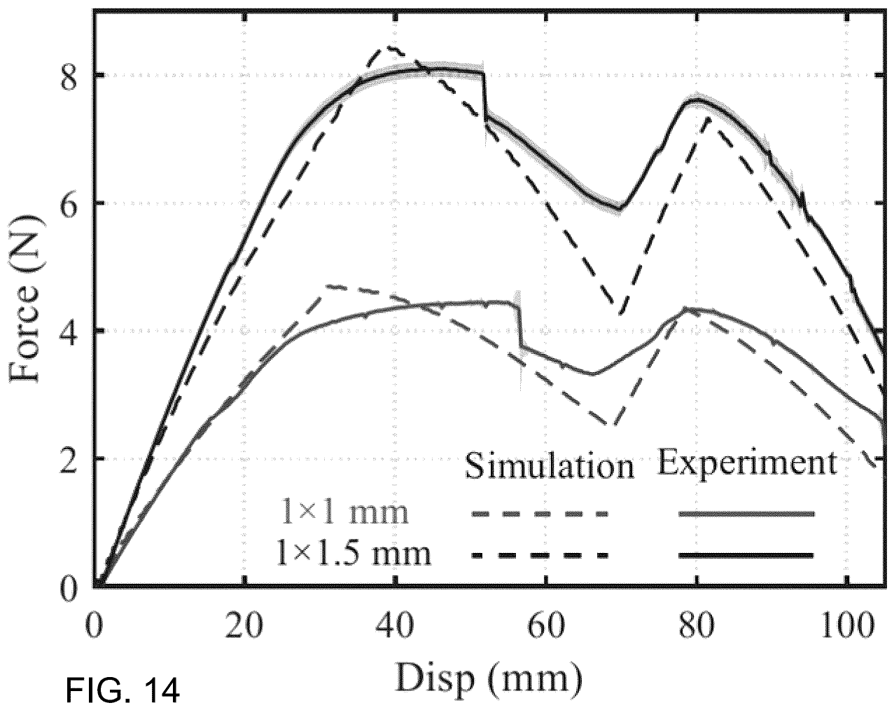

The force required to collapse a tensegrity wheel was analyzed for given parameters, such as the width and thickness of elastic cables, according to embodiments of the present disclosure. FIG. 14 illustrates the comparison of the simulation and experimental results for the force-displacement relationship when collapsing a tensegrity wheel. In some aspects, it is important to know the force required to collapse a tensegrity wheel to provide design guidelines for using the tensegrity structures as wheels. In some examples, knowing the force required to collapse a tensegrity wheel is important for selecting a motor that can generate enough torque to collapse the wheel. In some examples, knowing the force required to collapse a tensegrity wheel is important for structural design of the tensegrity wheel.

When the rod length is fixed, the collapsing force mainly depends on the property of the elastic cables (e.g., the initial prestretch and the dimensions for the cross section). It is challenging to establish an analytical model because of the complex nature of the problem, such as the nonlinearity of the elastic cables and potential contact/slide between rods during the deformation. Therefore, in the example, FEA was utilized to determine the collapsing force with respect to the cable displacements.

To use FEA to analyze the force in the example, the force-displacement relationship for a single elastic cable was first experimentally obtained, since its behavior (e.g., creep, hyper-elastic, etc.) is complex and cannot be easily modeled. Two cables were tested with different cross-sectional dimensions (1×1 mm and 1×1.5 mm) using a test stand (ESM303, Mark-10) with an M5-2 force gauge. The elastic cable was stretched to the same length as it would be on one embodiment of the expanded tensegrity (83 mm) and then allowed to wait for 10 minutes to remove the creeping effect in the TPU material. Then, the force-displacement relationship was measured by releasing or loading the cable (when a tensegrity wheel is collapsed, some elastic cables stretch while others relax) with a velocity of 0.85 mm/s. This velocity matches the velocity at which the elastic cables in the tensegrity wheel are stretched/relaxed when the wheel is collapsed, allowing cancellation of the influence of dynamic effects of the material such as creeping and damping.

With the experimental data for a single elastic cable, FEA was conducted using Abaqus (6.14, Dassault Systèmes) to predict the force-displacement relationship when the tensegrity wheel is collapsed. Nonlinear springs (CONN3D2) were used for the elastic cables and the nonlinear springs were defined by using the experimentally obtained force-displacement relationship. The rods were modeled with beam elements (B31); the wheel hub was simplified to a rigid triangle (CONN3D2); the connection of the rigid hub and the rods was simplified as a spherical joint. Contact between the rods was created with “Edge-to-Edge” contact. The contact between rods is important, as the tensegrity wheel cannot be compressed into a flat shape without contact. The simulation started with a static step to let the prestretch come to a steady state, during which the pretension in the clastic cable will add load to the tensegrity structure. Then, an implicit dynamic step with moderate damping was simulated. The simulation results are plotted as dashed lines in FIG. 14.

To validate the simulation results, the force-displacement relationship for collapsing a tensegrity wheel was also experimentally obtained. During the experiments, one hub was fixed and the wheel was compressed using the same testing stand and force gauge. Experiments for two tensegrity wheels were conducted with clastic cables of the same dimensions used in the simulation. For each cable, the experiments were repeated three times. The results are plotted as solid lines representing the mean value in FIG. 14. The results suggest a considerable reduction in the required force at a little over halfway through the collapsing process (60 mm). This reduction is due to some members applying a force in the direction of collapse after some rods contact each other.

As shown in FIG. 14, the simulated force with respect to the displacement has a similar shape to the experimental results. Furthermore, the predicted maximum force is only 5% off from the experimental result (8 N) for the tensegrity wheel using 1×1.5 mm cross-sectional TPU. The discrepancy might be due to the elastic cables having different moving (stretching or relaxing) speeds during the collapsing process, as cables moving slower might have a creep effect. Due to the good accuracy in predicting the maximum force, the simulation can be used for wheels of different sizes.

As previously noted, determining the maximum force during compression can aid in selecting a proper motor to collapse the wheels. In one embodiment, the tensegrity wheel attached to the robot uses the TPU cable with a cross section of 1×1.5 mm because these dimensions result in adequate tension in a single tensegrity structure to hold the robot's weight (250 g) without collapsing. Based on the experimental results from the tensegrity wheels used on the embodiment of the robot (1×1.5 mm), a minimum of 16 N (8 N for each wheel) is required to collapse both tensegrity wheels. Therefore, in one embodiment, a gear motor (Pololu item: 1595) with a continuous torque supply of 0.19 Nm (which can generate a force of 38 N when using a 10-mm diameter pulley) is used. Although only 16 N was required to collapse both wheels, much more force is needed on uneven terrain because the wheels must drag across the ground. Therefore, in the embodiment, a motor that can at least supply double the minimum required force was selected.

### Example 2—Analysis of Maximum Climbable Step Height

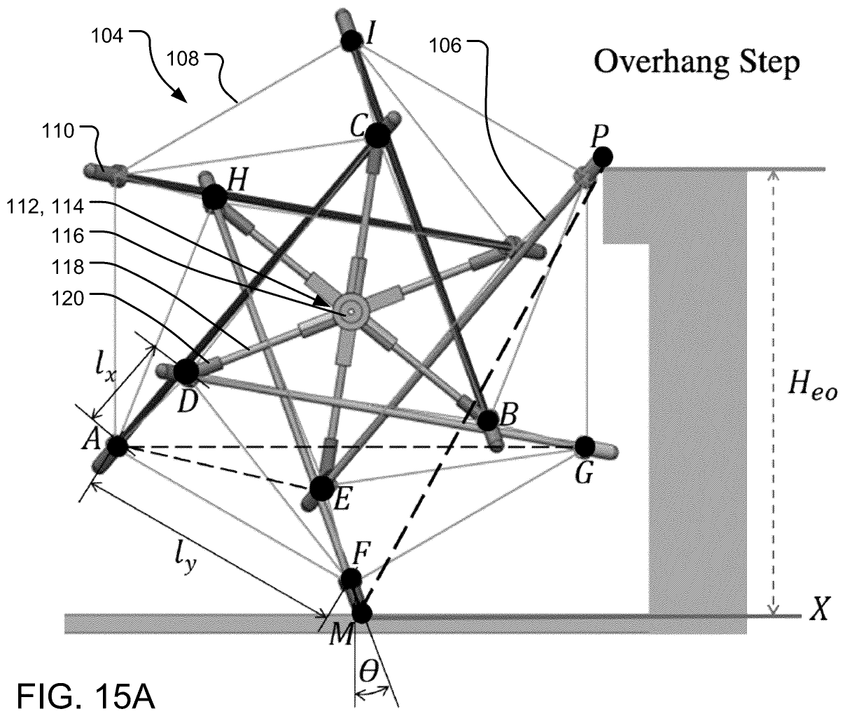

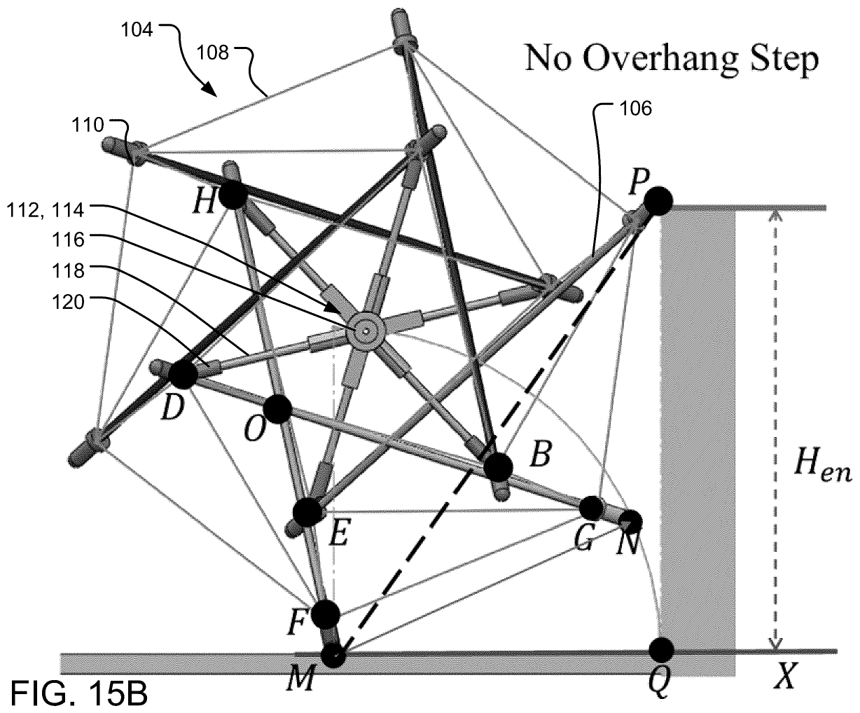

The maximum step height that a tensegrity wheel can climb in either an expanded or collapsed state was analyzed for given the rod length lᵣ, according to embodiments of the present disclosure. FIG. 15A illustrates a maximum climbable step height with an overhang. The height is achieved when the end caps of rod EP and rod DG are aligned vertically, which can only occur if the step has an overhang. FIG. 15B illustrates a maximum climbable height for a step without an overhang. In some aspects, it is important to know the maximum step height a tensegrity wheel can climb to provide design guidelines for using the tensegrity structures as wheels. For example, deriving the height as a function of the rod length lᵣ in the tensegrity structure can aid in the design of tensegrity wheels. This guideline can be used to design tensegrity wheels with a proper lᵣ for climbing specific heights. Two cases of an expanded or collapsed wheel—steps with and without an overhang—were analyzed. For both cases, the mathematical expressions for the maximum step height was derived as a function of lᵣ based on the inherent geometry.

Maximum Climbable Height with Expanded Wheels: When the wheels are expanded, the maximum climbable height was obtained by projecting the 3D wheel onto a plane parallel to the wheel hubs to obtain a 2D view of the wheel as shown in FIG. 15A. The projected lengths for all 6 rods and 12 end caps are the same, which are known parameters. They are denoted as l′ᵣ and l′ₑ, respectively. In this projected 2D view, the whole wheel becomes a regular hexagon, with each vertex located at one end of each rod.

Parameters were solved that could be used for both cases—with an overhang and without an overhang—such as the length of |AD| (denoted as lₓ) and the length of |AF| (denoted as l_{y}). In ΔAEF and ΔADG, there can be the following two equations using the law of cosines:

$$\begin{matrix}{l}_{y}^{2} = {\vert AE \vert}^{2} + {l}_{x}^{2} - 2 \vert AE \vert {l}_{x} cos 120 ° & ( 1 ) \\ {\vert AG \vert}^{2} = {l}_{x}^{2} + {l}_{r}^{′2} - 2 {l}_{x} {l}_{r}^{′} cos 120 ° & ( 2 )\end{matrix}$$

The following can also be solved: |AE|=l′ᵣ/2 from ΔACE, and |AG|=\sqrt{3}l_{y}, from ΔAFG. Plugging |AE| and |AG| into the two equations, can solve lₓ=l′ᵣ/4, and l_{y}=\sqrt{7}l′ᵣ/4.

For the case with an overhang (as illustrated for example in FIG. 15A), the end of rod DG can freely rotate inside the overhang without contacting the step. This results in a configuration where the cable PG connecting rod EP and DG is vertical. To solve the climbing height, |MP| and the ∠PMX can be solved to obtain the height as Hₑₒ=|MP| sin ∠PMX. To solve ∠PMX, the angle θ of the end-cap at point M with respect to the vertical line can be solved, which is equal to ∠HFI. In ΔHFI, there is |HI|=|AE|=l′ᵣ/2, |FI|=2l_{y}, and |HF|=l′ᵣ. Then, the following can be solved: θ=arccos(|HF|²+|FI|²−|HI|²/(2|HF|×|FI|))=19°. Then, ∠PMX=90°−(∠EMP−θ), where ∠EMP can be obtained in ΔEMP using the law of sines. Finally, |MP| can be solved using the law of cosines in ΔEMP with |EM|=l′ᵣ/4+l′ₑ, |EP|=l′ᵣ+l′ₑ, and ∠MEP=120°. For the rod length lᵣ=130 mm and end-cap length lₑ=12 mm, the projected length l′ᵣ=104 mm and l′ₑ=10 mm. Plugging them into the equations can solve Hₑₒ=122 mm.

For the case without overhang (as illustrated for example in FIG. 15B), the end of rod DG will contact the step first and push the wheel away, further rotating rod HF before rod EP touches the top of the step, which reduces the maximum step height that can be climbed. For rod EP to contact the step before rod DG, the step can be located at a distance no closer than the arc (shown in blue in FIG. 15B) originating from M, the end of rod HF, and terminating at N, the end of rod DG. To obtain the maximum climbable height |PQ|, then |MP| and |MQ| can be solved, respectively, and then, |PQ| can be solved in the right triangle ΔPQM as Hₑₙ=\sqrt{|MP|²−|MQ|²}. |MP| can be solved similarly to the case with an overhang by using the law of cosines in ΔEMP. |MQ|=|MN|, which can also be solved by using the law of cosines in ΔOMN with |OM|=|OF|+|FM|=l′ᵣ/2+l′ₑ and |ON|=|OG|+|GN|=3l′ᵣ/4+l′ₑ. For l′ᵣ=104 mm and l′ₑ=10 mm, |PQ| can be solved as Hₑₙ=111 mm.

Maximum Climbable Height with Collapsed Wheels: Surprisingly, when the wheels are collapsed, the resulting 2D shape is almost the same as the projected shape of the original 3D tensegrity. In this 2D shape, the lengths for the rod and end-cap change to the original length, lᵣ and lₑ, respectively. In this case, the analysis in the previous subsection can be directly used by replacing l′ᵣ with lᵣ and l′ₑ with lₑ. For lᵣ=130 mm and lₑ=12 mm, we can calculate the maximum height for the case with and without overhang to be, respectively, H_{co}=149 mm and H_{cn}=138 mm.

Although in one embodiment lᵣ=130 mm, lᵣ can be other values. In some embodiments, lᵣ can be between approximately 50 mm and approximately 500 mm. In some aspects, it can be beneficial for lᵣ to be between 50 and 500 mm considering practical constraints from fabrication and the usage as a wheel. Although in one embodiment lₑ=12 mm, lₑ can be other values. In some embodiments, lₑ can be between approximately 10 mm and approximately 20 mm. In some aspects, it can be beneficial for lₑ to be between 10 and 20 mm. Although increasing lₑ can aid in overcoming obstacles it can also increase the difficulty to roll the tensegrity wheel. Moreover, longer end-caps can be more easily damaged.

### Example 3—Wheeling Test

A robot with two icosahedron tensegrity wheels was evaluated to determine how it will move on the ground and also to determine the step size, since a single icosahedron tensegrity will roll on the ground in a zig-zag fashion, according to embodiments of the present disclosure. A simplified model was built by connecting two tensegrity wheels with a shared square shaft, which allows the wheels to roll in phase. To avoid other effects (e.g., slippage), the pair of wheels as manually rotated. The results show that the two tensegrity wheels contact the ground with the same endcaps in a zig-zag fashion. But since the two wheels are symmetric with respect to the robot body, the robot moves forward linearly. From the experiments, the robot can move 86.6 and 99.6 mm per step for the expanded and collapsed wheel, respectively.

### Example 4—Jumping Height Test

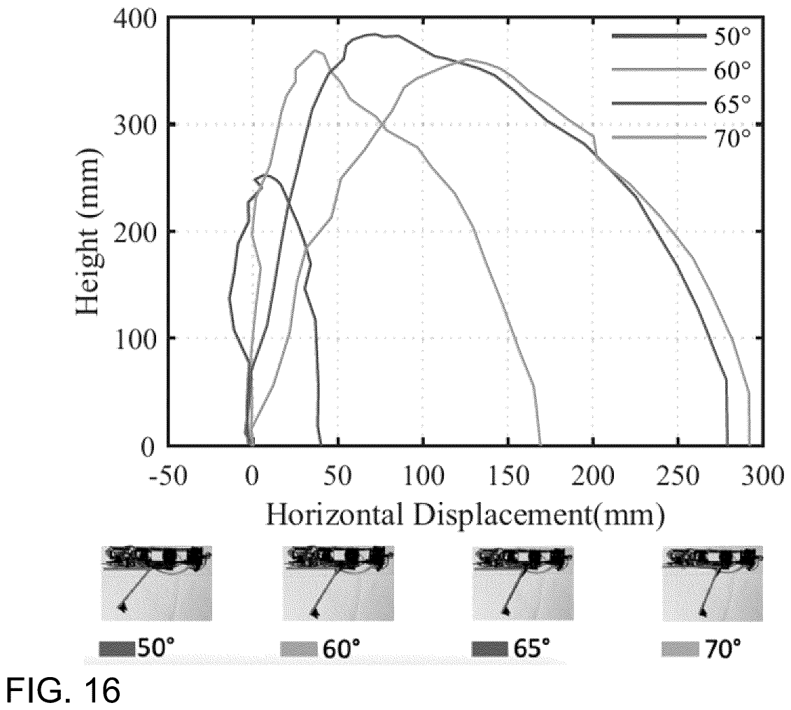

Jumping experiments were performed to determine an optimal position of the jumping foot on the carbon fiber plate, according to embodiments of the present disclosure. In some aspects, the robot can have a steep takeoff angle to optimize jumping height while clearing obstacles. For case of testing, the foot was tested at four locations, corresponding to angles of 50°, 60°, 65°, and 70° relative to the robot's body, as shown at the bottom of FIG. 16. FIG. 16 illustrates the results for the max jumping height experiment showing the jumping trajectory (an average of three tests for each angle of the jumping foot ranging from 50 to 70° as shown in the inset) of the center of the robot's wheel. The maximum height deviation for three repeated experiments was 3 mm.

For each jumping test, the robot was placed on a hard surface, and a marker was attached to the center of the wheel's hub to indicate the robot's position for tracking purposes. A video of the jump was recorded using an iPhone camera. The recorded video was then analyzed using video tracking software (Tracker), which can automatically track the attached sticker in the video to plot the robot's relative position as it jumped. Three jumping tests are conducted for each angle of the jumping foot, and the results are plotted in FIG. 16.

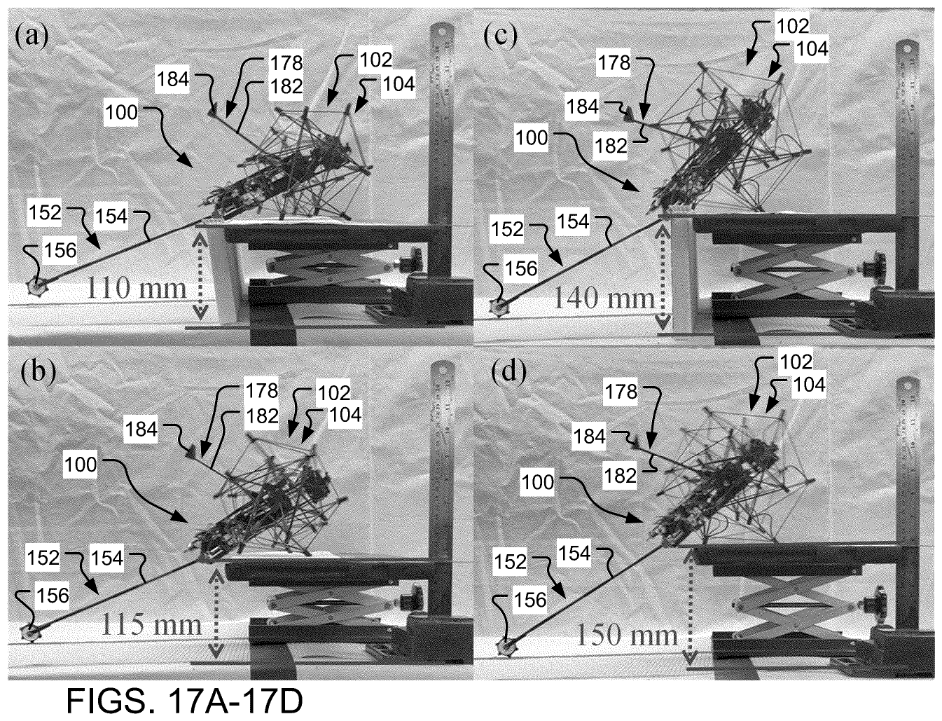

As illustrated in FIG. 16, the maximum jumping height measured from the center of the robot's wheel was 384 mm, with the jumping foot at an angle of 65° from the robot's body. While the robot's center of mass (approximately located at the center of the robot between the two wheels) moved upward 384 mm for the highest jump, the maximum obstacle clearance is approximately 300 mm due to the jumping foot being below the robot body. Nonetheless, a 300-mm obstacle jumping height can be twice the maximum step height achievable with collapsed wheels (as depicted in FIGS. 17D, which is discussed further below).

### Example 5—Inclined Slope Test

An experiment was conducted on a robot having tensegrity wheels to determine the maximum slope the robot could climb using tensegrity wheels, according to embodiments of the present disclosure. Climbing steep slopes is advantageous for robotic navigation in natural and urban environments.

The 7.4-V battery was fully charged before each test to ensure consistency between tests. Then, the robot was placed on a variable-degree angled slope made from thick foam with a high friction cabinet liner on top. The static coefficient of friction was measured between the tensegrity wheels and the high friction liner to be 0.78. In some aspects, this surface allowed the robot to climb a slope with minimal slipping. The slope angle was incrementally raised by 5° intervals until the robot could not ascend further. The robot ascended inclines up to 35° without slippage. However, at a slope of ˜40°, slipping occurred, though the robot still managed to ascend. The maximum incline that the robot could climb was 45°. A second test was conducted without the high grip liner, where the static coefficient of friction between the tensegrity wheel and polystyrene foam was measured to be 0.57. On this surface, the robot could climb a slope of approximately 40°.

### Example 6—Maximum Climbable Step Height Test

To validate the models in Example 2 (above), the maximum climbable step height for the expanded and collapsed wheels (each for the two cases with and without an overhang) was tested, according to embodiments of the present disclosure. FIGS. 17A-17D illustrate the four different step-climbing cases that were tested. As illustrated in FIG. 17A, expanded wheels can climb a step with no overhang of 110 mm. As illustrated in FIG. 17B, expanded wheels can climb a step with an overhang of 115 mm. As illustrated in FIG. 17C, collapsed wheels can climb a step with no overhang of 140 mm. As illustrated in FIG. 17D, collapsed wheels can climb a step with an overhang of 150 mm.

The robot was placed on a flat surface with a variable height step (either with or without an overhang) in front of it. Then, the robot rolled forward until it encountered the step. The step height was increased between each test with an interval of 5 mm until the robot could no longer climb up. The results are shown in FIGS. 17A-17D, which validated the model prediction from Example 2 (above). Among all the four heights, only Hₑₒ was 6% larger than the experimental result (predicted value was 122 mm with experimental value 115 mm). This discrepancy appears to be caused by the robot's front body getting stuck under the overhanging step when it is 120-mm tall.

### Example 7—Field Experiments

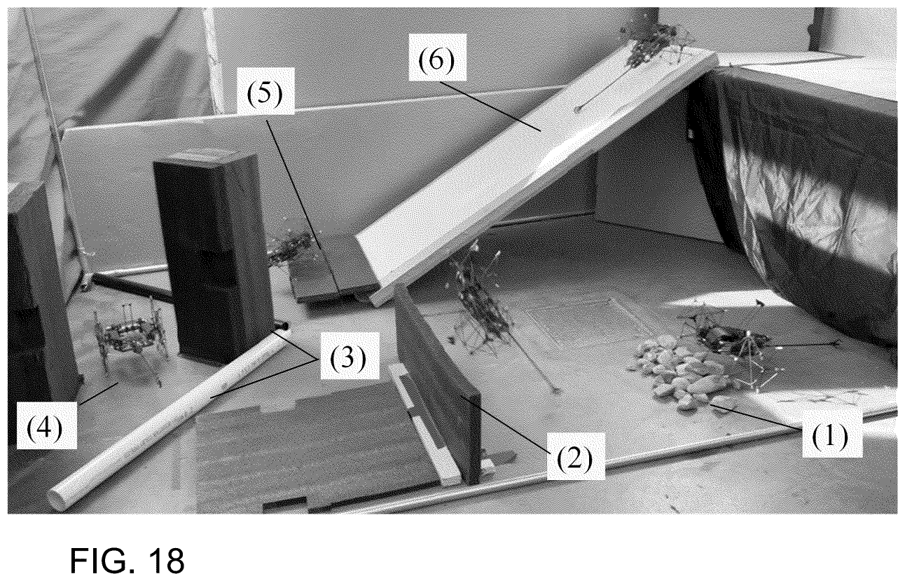

To showcase the robot's capabilities in a single environment, according to embodiments of the present disclosure, an obstacle course was constructed, as shown in FIG. 18. FIG. 18 illustrates an obstacle course that was constructed to demonstrate the robot's ability to navigate different terrains, including uneven rubble 1 including rocks, a wall 2 having a height of 250-mm, round pipes 3 that were loose, a 200-mm wide gap 4, a step 5 having a height of 100-mm, and an inclined ramp 6 having a slope of 35°.

The course allowed the robot to locomote through different terrain features such as traversing a rock pile, jumping over a wall, climbing over loose round pipes, passing through a narrow gap, moving up a step, and climbing a ramp. In a single run, the robot could traverse through all obstacles. Additionally, payload experiments were conducted on the robot by adding liquid-filled bottles to the robot until it could no longer move forward. The example robot could carry a payload of 1222 g, which is 4.9 times its weight, demonstrating its high load-carrying capacity.

Besides indoor tests, the robot's performance was tested in various outdoor real-world environments. FIGS. 19A-19G, illustrates the example robot traversing across grass 14 (FIG. 19A), gravel 15 (FIG. 19B), sand 16 (FIG. 19C), sharp rocks 17 (FIG. 19D), foliage 18 (FIG. 19E), snow 19 (FIG. 19F), and ice 20 (FIG. 19G).

### Example 8—Robotic Arm Navigating Vertical Pipe

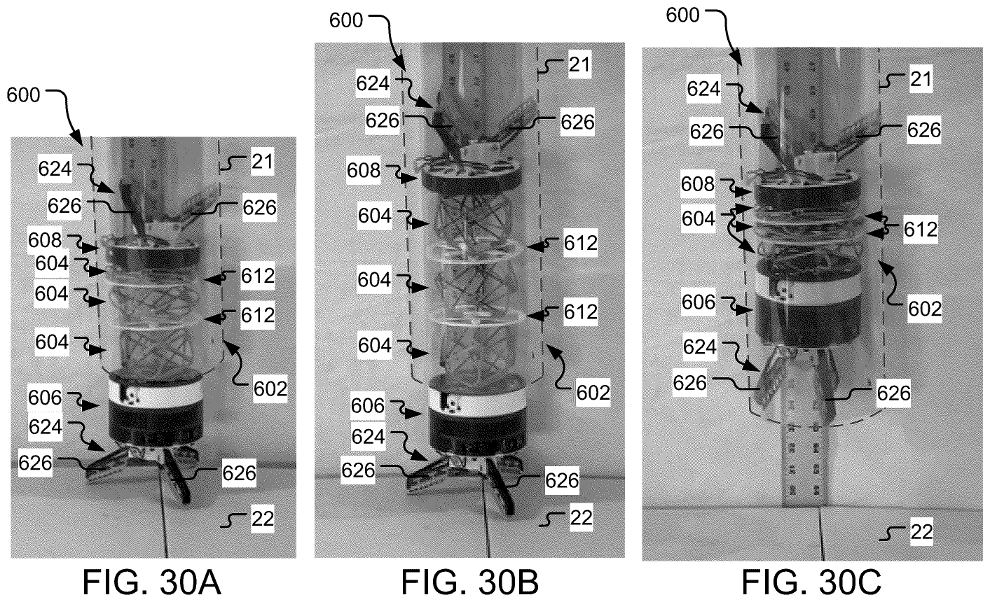

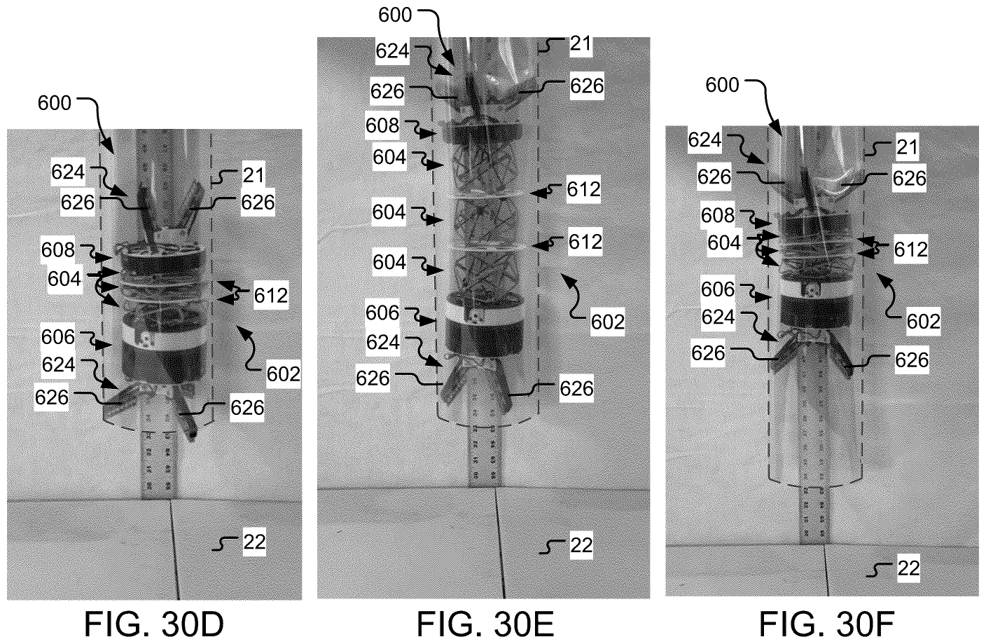

An example robot 600 was used to traverse or otherwise navigate a vertical pipe 21, as illustrated in FIGS. 30A-30F. First, during the time between FIG. 30A and FIG. 30B, the length of the robotic arm 602 (e.g., length of the tensegrity structures 604) was increased. Because the jaws 626 of the lower end effector 624 were positioned on the ground 22 (as illustrated in FIG. 30A), increasing the length of the robotic arm 602 caused the position of the second base 608 to extend vertically upward away from the first base 606 (as illustrated in FIG. 30B).

Then, during the time between FIG. 30B and FIG. 30C, the jaws 626 of the upper end effector 624 were opened such that they pushed against the inner wall of the vertical pipe 21 to maintain the position of the second base 608 and the length of the robotic arm 602 (e.g., length of the tensegrity structures 604) was decreased. Because the jaws 626 of the upper end effector 624 were fixed with respect to the vertical pipe 21 (as illustrated in FIG. 30B), decreasing the length of the robotic arm 602 caused the position of the first base 606 to retract vertically upward toward the second base 608 and into the vertical pipe 21 (as illustrated in FIG. 30C).

Next, during the time between FIG. 30C and FIG. 30D, the jaws 626 of the lower end effector 624 were opened such that they pushed against the inner wall of the vertical pipe 21 to maintain the position of the first base 606. And the jaws 626 of the upper end effector 624 were closed such that they no longer pushed against the inner wall of the vertical pipe 21.

Then, during the time between FIG. 30D and FIG. 30E, the length of the robotic arm 602 (e.g., length of the tensegrity structures 604) was increased. Because the jaws 626 of the lower end effector 624 were fixed with respect to the vertical pipe 21 (as illustrated in FIG. 30D), increasing the length of the robotic arm 602 caused the position of the second base 608 to extend vertically upward away from the first base 606 (as illustrated in FIG. 30E).

Then, during the time between FIG. 30E and FIG. 30F, the jaws 626 of the upper end effector 624 were opened such that they pushed against the inner wall of the vertical pipe 21 to maintain the position of the second base 608 and the length of the robotic arm 602 (e.g., length of the tensegrity structures 604) was decreased. Because the jaws 626 of the upper end effector 624 were fixed with respect to the vertical pipe 21 (as illustrated in FIG. 30E), decreasing the length of the robotic arm 602 caused the position of the first base 606 to retract vertically upward toward the second base 608 and further into the vertical pipe 21 (as illustrated in FIG. 30F).

### Example 9—Two Robotic Arms Working in Concert

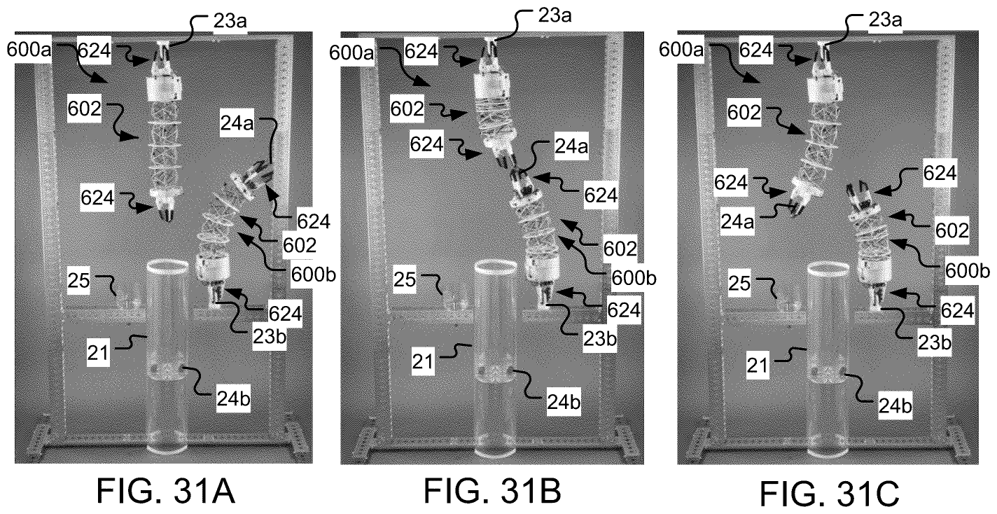

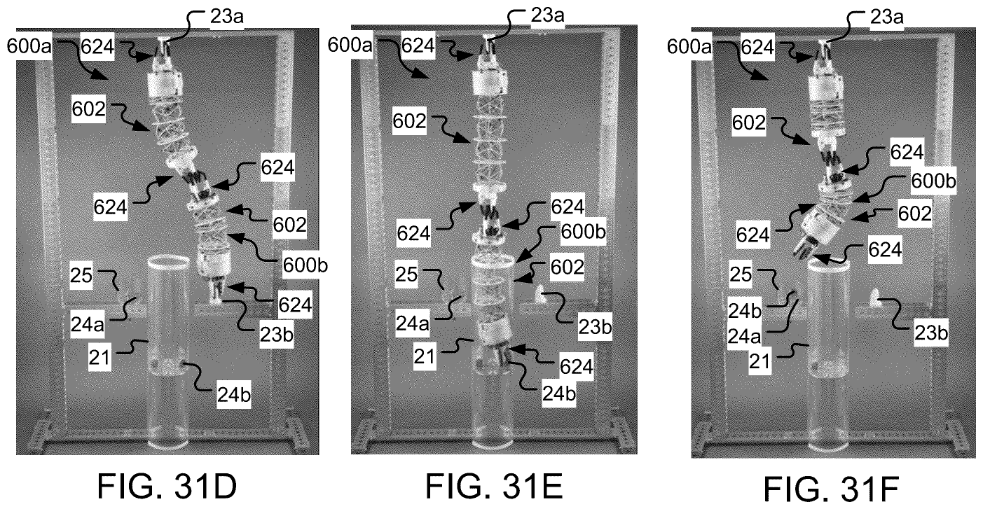

Two example robots 600 (i.e., first example robot 600a, second example robot 600b) were used to demonstrate certain functions of the robots 600, as illustrated for example in FIGS. 31A-31F. First, during the time between FIG. 31A and FIG. 31B, the upper end effector 624 (e.g., jaws) of the second robot 600b was actuated (e.g., closed) to grip a first object 24a. With the lower end effector 624 of the second robot 600b gripping structure 23b, the robotic arm 602 of the second robot 600b was rotated and retracted. With the upper end effector 624 of the first robot 600a gripping the structure 23a, the robotic arm 602 of the first robot 600a was rotated and retracted.

Then, during the time between FIG. 31B and FIG. 31C, the lower end effector 624 of the first robot 600a was actuated to grip the first object 24a and the upper end effector 624 (e.g., jaws) of the second robot 600b was actuated (e.g., opened) to release the first object 24a. With the upper end effector 624 of the first robot 600a gripping the structure 23a, the robotic arm 602 of the first robot 600a was rotated and extended.

Then, during the time between FIG. 31C and FIG. 31D, the lower end effector 624 of the first robot 600a was opened to release the first object 24a into the cup 25. With the upper end effector 624 of the first robot 600a gripping the structure 23a, the robotic arm 602 of the first robot 600a was rotated and extended. The lower end effector 624 of the first robot 600a was closed to grip the upper end effector 624 of the second robot 600b.

Then, during the time between FIG. 31D and FIG. 31E, with the upper end effector 624 of the first robot 600a gripping the structure 23a, the robotic arm 602 of the first robot 600a was rotated and extended. With the lower end effector 624 of the first robot 600a coupled to the upper end effector 624 of the second robot 600b, the robotic arm 602 of the second robot 600b was rotated and extended into the vertical pipe 21. The lower end effector 624 of the second robot 600b was closed to grip the second object 24b.

Then, during the time between FIG. 31E and FIG. 31F, with the upper end effector 624 of the first robot 600a gripping the structure 23a, the robotic arm 602 of the first robot 600a was retracted. With the lower end effector 624 of the first robot 600a coupled to the upper end effector 624 of the second robot 600b, the robotic arm 602 of the second robot 600b was retracted and rotated. The lower end effector 624 of the second robot 600b was opened to release the second object 24b into the cup 25.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustrations only and are not intended to limit the scope of the present invention. References to details of particular embodiments are not intended to limit the scope of the invention.

What is claimed is:

1. A robotic wheel comprising:
a tensegrity structure defining a longitudinal axis, the tensegrity structure including:
a plurality of rigid rods; and
a plurality of elastic cables;
an inner hub disposed at a first end of the tensegrity structure;
an outer hub disposed at a second end of the tensegrity structure; and
a cable contacting the outer hub, extending through the tensegrity structure parallel to the longitudinal axis of the tensegrity structure, and extending through the inner hub, the cable operable to retract to transition the tensegrity structure to a collapsed state and to extend to transition the tensegrity structure an expanded state.

2. The robotic wheel of claim 1, wherein the cable extends through the tensegrity structure coincident to the longitudinal axis of the tensegrity structure.

3. The robotic wheel of claim 1, further comprising a hollow shaft coupled to the inner hub, the hollow shaft coincident to the longitudinal axis of the tensegrity structure.

4. The robotic wheel of claim 1, wherein a plane defined by the outer hub is substantially perpendicular to the longitudinal axis of the tensegrity structure when the tensegrity structure is in the expanded state, the collapsed state, and transitioning between the expanded state and the collapsed state.

5. The robotic wheel of claim 1, wherein a plane defined by the inner hub is substantially parallel to a plane defined by the outer hub when the tensegrity structure is in the expanded state, the collapsed state, and transitioning between the expanded state and the collapsed state.

6. The robotic wheel of claim 1, wherein the outer hub is coupled to outer ends of at least a portion of the plurality of rigid rods via compliant connectors.

7. The robotic wheel of claim 1, wherein each opposing end of each of the plurality of rigid rods includes an endcap configured to increase friction between the tensegrity structure and a surface supporting the tensegrity structure.

8. The robotic wheel of claim 1, wherein the tensegrity structure defines a width, wherein the width of the tensegrity structure is greater in the expanded state than in the collapsed state.

9. The robotic wheel of claim 1, wherein the tensegrity structure defines a height, wherein the height of the tensegrity structure is greater in the collapsed state than in the expanded state.

10. The robotic wheel of claim 1, wherein the tensegrity structure includes six rigid rods and twenty-four elastic cables, the six rigid rods and the twenty-four elastic cables arranged in a 6-bar icosahedron tensegrity structure.

11. A robot comprising:
a body;
a first tensegrity wheel coupled to a first shaft extending outward from a first side of the body, the first tensegrity wheel operable to rotate about a first longitudinal axis; and
a second tensegrity wheel coupled to a second shaft extending outward from a second side of the body, the second tensegrity wheel operable to rotate about a second longitudinal axis.

12. The robot of claim 11, further comprising:
a third tensegrity wheel coupled to a third shaft extending outward from the first side of the body, the third tensegrity wheel operable to rotate about a third longitudinal axis; and
a fourth tensegrity wheel coupled to a fourth shaft extending outward from the second side of the body, the fourth tensegrity wheel operable to rotate about a fourth longitudinal axis.

13. The robot of claim 11, wherein the first tensegrity wheel is operable to transition between an expanded state and a collapsed state along the first longitudinal axis, wherein the second tensegrity wheel is operable to transition between an expanded state and a collapsed state along the second longitudinal axis.

14. The robot of claim 13, wherein the robot defines a width, wherein when each of the first tensegrity wheel and the second tensegrity wheel are in the expanded state the width of the robot is greater than when each of the first tensegrity wheel and the second tensegrity wheel are in the collapsed state.

15. The robot of claim 13, wherein the robot defines a clearance height, wherein when each of the first tensegrity wheel and the second tensegrity wheel are in the collapsed state the clearance height of the robot is greater than when each of the first tensegrity wheel and the second tensegrity wheel are in the expanded state.

16. The robot of claim 11, further comprising a jumping mechanism coupled to the body, the jumping mechanism configured actuate to cause the robot to separate from a surface supporting the robot.

17. The robot of claim 16, wherein the jumping mechanism comprises a bistable mechanism.

18. The robot of claim 11, further comprising a tail extending from a back side of the body.

19. The robot of claim 11, further comprising a first plurality of paddles couplable to the first tensegrity wheel and a second plurality of paddles couplable to the second tensegrity wheel.

20. The robot of claim 11, further comprising an unmanned aerial vehicle coupled to the body.

21. A robotic arm comprising:
a first base including a first end effector;
a second base including a second end effector;
one or more tensegrity structures disposed in series between the first base and the second base, the one or more tensegrity structures defining a longitudinal axis; and
a plurality of cables extending between the first base and the second base, each of the plurality of cables configured to retract towards or extend from the first base, each of the plurality of cables being substantially parallel to the longitudinal axis when the longitudinal axis is substantially linear.

22. The robotic arm of claim 21, further comprising a cable guide extending radially outward from an interface between a first tensegrity structure and a second tensegrity structure, the cable guide including a plurality of apertures corresponding to the plurality of cables, wherein the first tensegrity structure and the second tensegrity structure are included in the one or more tensegrity structures.

23. The robotic arm of claim 21, wherein each of the plurality of cables are equally spaced along a circumference defined radially outward from the longitudinal axis.

24. The robotic arm of claim 21, wherein the plurality of cables includes a first cable, a second cable, and a third cable.

25. The robotic arm of claim 24, further comprising a first motor, a second motor, and a third motor each enclosed withing a housing of the first base, the first motor configured to retract or extend the first cable, the second motor configured to retract or extend the second cable, and the third motor configured to retract or extend the third cable.

26. The robotic arm of claim 21, wherein the robotic arm expands or contracts along the longitudinal axis when each of the plurality of cables are extended or retracted at a same rate.

27. The robotic arm of claim 21, wherein the longitudinal axis transitions between a straight configuration and a bent configuration when at least two cables of the plurality of cables are extended or retracted at a different rate.

28. The robotic arm of claim 21, wherein each of the plurality of cables defines a length between the first base and the second base, wherein the longitudinal axis is substantially linear when the length of each of the plurality of cables are substantially equal.

29. The robotic arm of claim 21, wherein each of the plurality of cables defines a length between the first base and the second base, wherein the longitudinal axis is substantially non-linear when the length a first cable is different than a second cable, wherein the first cable and second cable are included in the plurality of cables.

30. The robotic arm of claim 21, wherein the first end effector includes a first robotic claw extending outward from the first base, wherein the second end effector includes a second robotic claw extending outward from the second base, each of the first robotic claw and the second robotic claw operable to transition between an open position and a closed position.
